(19) United States
(12) Patent Application Publication
(10) Pub. No.: US 2016/0244607 A1
(43) Pub. Date: Aug. 25, 2016

(54) FLAME RETARDANT THERMOSET COMPOSITIONS

(71) Applicant: FRX Polymers, Inc., Chelmsford, MA (US)

(72) Inventors: Lawino KAGUMBA, Cambridge, MA (US); Jan-Pleun LENS, Boston, MA (US)

(21) Appl. No.: 15/049,998

(22) Filed: Feb. 22, 2016

Related U.S. Application Data
(60) Provisional application No. 62/118,673, filed on Feb. 20, 2015.

(51) Int. Cl. C08L 67/06; C08L 85/02

(52) U.S. Cl. CPC C08L 67/06; C08L 85/02

(57) ABSTRACT

Methods for curing unsaturated polyesters or vinyl esters in compositions that include oligomeric phosphates, oligomeric phosphonates, and combinations thereof and compositions and cured polymers made by these methods are described herein.

### CROSS-REFERENCE TO RELATED APPLICATIONS

This application claims benefit of and priority to U.S. Provisional Application No. 62/118,673, filed Feb. 20, 2015, entitled “Flame Retardant Thermoset Compositions,” the contents of which are incorporated herein by reference in its entirety.

### BACKGROUND

Unsaturated polyester resins are typically cured using organic peroxide systems in combination with a cobalt promoter. At room temperature, these resin compositions gel in under ten minutes in the presence of organic peroxides like methyl ethyl ketone peroxide (MEK-P). Compositions containing oligomeric phosphates or oligomeric phosphonates do not readily gel at room temperature when equivalent levels of cobalt and peroxide systems are used. As a result, the materials cure slowly and remain sticky, making removal from molds difficult.

### SUMMARY OF THE INVENTION

Various embodiments of the present invention relate to a composition containing an unsaturated polyester, an oligomeric phosphonate, oligomeric phosphate, or combinations thereof, and a cobalt-free catalyst system.

In some embodiments, the cobalt-free catalyst system may contain a transition metal-containing promoter selected from copper¹⁺ compounds, copper²⁺ compounds, iron²⁺ salts, iron³⁺ compounds, iron²⁺ salts, organic iron²⁺ salts, iron³⁺ salts, organic iron³⁺ salts, manganese²⁺ salts or complexes, manganese³⁺ salts or complexes, organic manganese²⁺ salts, organic manganese³⁺ salts, titanium compounds, and organotitanium compounds.

In some embodiments, the cobalt-free catalyst system may contain a transition metal-containing promoter selected from copper carboxylates, copper acetoacetates, copper chlorides, iron carboxylate, iron acetoacetate, manganese carboxylate, manganese acetoacetate, titanium alkoxidetitanium propoxide, titanium butoxide, titanium carboxylate, and combinations thereof.

In some embodiments, the oligomeric phosphonate may have a weight average molecular weight (Mw) of about 1,000 g/mole to about 18,000 g/mole, as determined by ηᵣₑₗ or GPC.

In some embodiments, the phosphonate component may have a number average molecular weight (Mn) of about 500 g/mole to about 10,000 g/mole.

In some embodiments, the phosphonate component may have a molecular weight distribution (Mw/Mn) of about 2 to about 7.

In some embodiments, the phosphonate component may have a relative viscosity of from about 1.01 to about 1.20.

In some embodiments, the phosphonate component may have a phosphorous content of about 1% to about 20% by weight.

In some embodiments, the oligomeric phosphonate may be of Formula I:

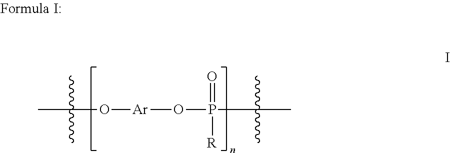

in which Ar is an aromatic group; —O-Ar-O— is derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations thereof; R is a C₁₋₂₀ alkyl, C₂₋₂₀ alkene, C₂₋₂₀ alkyne, C₅₋₂₀ cycloalkyl, or C₆₋₂₀ aryl; and n is an integer from 1 to about 20.

In some embodiments, the oligomeric phosphonate may be of Formula II:

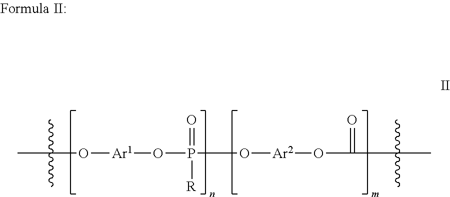

in which Ar¹ and Ar² are aromatic groups; each —O-Ar¹-O— and —O-Ar²—O— is, individually, derived from resorcinol, hydroquinone, bisphenol A, bisphenol F, 4,4′-biphenol, phenolphthalein, 4,4′-thiodiphenol, 4,4′-sulfonyl di phenol, 1,1-bis-(4-hydroxyphenyl)-3,3,5-trimethylcyclohexane, and combinations thereof; each R is, independently, C₁₋₂₀ alkyl, C₂₋₂₀ alkene, C₂₋₂₀ alkyne, C₅₋₂₀ cycloalkyl, or C₆₋₂₀ aryl; and each m and n is, independently, an integer from 1 to about 20.

In some embodiments, the oligomeric phosphonate may be of Formula III:

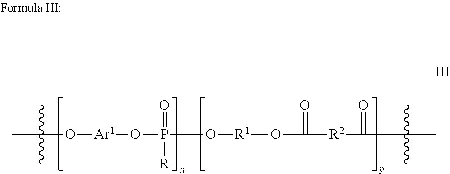

in which Ar¹ is an aromatic group; each —O-Ar¹—O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof; each R is, independently, C₁₋₂₀ alkyl, C₂₋₂₀ alkene, C₂₋₂₀ alkyne, C₅₋₂₀ cycloalkyl, or C₆₋₂₀ aryl; each R¹ and R² are, individually, aliphatic or aromatic hydrocarbons; and each n and p is, independently, an integer from 1 to about 20.

In some embodiments, the oligomeric phosphonate may be selected from compounds of Formulae IV, V, and VI:

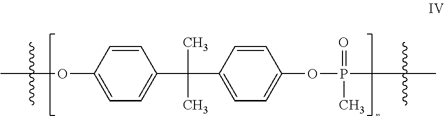

in which n is 1 to 20;

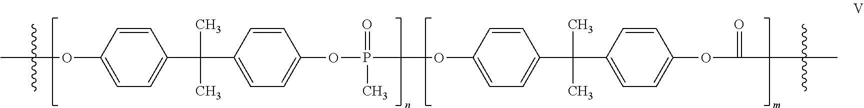

in which each n and m is, individually, 1 to 20; and

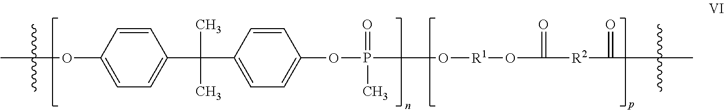

in which each n and p is, individually, 1 to 20.

In some embodiments, the composition may contain about 10% to about 40% by weight oligomeric phosphonate.

In some embodiments, the oligomeric phosphate may be of Formula XIV:

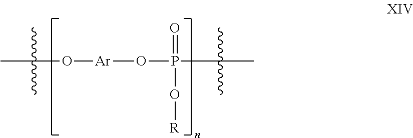

in which Ar is an aromatic group; —O-Ar-O— derived from resorcinol, hydroquinone, bisphenols, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of thereof; R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20.

In some embodiments, the oligomeric phosphates may have a weight average molecular weight (Mw) of about 300 g/mole to about 10,000 g/mole as determined by ηrel or GPC.

In some embodiments, the oligomeric phosphates may have a number average molecular weight (Mn) from about 500 g/mole to about 5000 g/mole.

In some embodiments, the oligomeric phosphate may be selected from trimethylphosphate, triethylphosphate, tripropylphosphate, tributylphosphate, tripentylphosphate, trihexylphosphate, tricyclohexylphosphate, triphenylphosphate, tricresylphosphate, trixylenylphosphate, dimethylethylphosphate, methyldibutylphosphate, ethyldipropylphosphate, and hydroxyphenyldiphenylphosphate.

In some embodiments, the composition may contain about 0.5 wt. % to about 15 wt. % oligomeric phosphate.

In some embodiments, the ratio of oligomeric phosphonate to oligomeric phosphate is about 10:1 to about 100:1.

In some embodiments, the unsaturated polyester may be selected from ortho-resins derived from phthalic anhydride, maleic anhydride, or fumaric acid and glycol, 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins derived from isophthalic acid, maleic anhydride or fumaric acid, and glycol, bisphenol-A-fumarates derived from bisphenol-A and fumaric acid, chlorendics derived from chlorine/bromine containing anhydrides or phenols, vinyl ester resins, vinyl ester resins containing epoxy resins, diglycidyl ether of bisphenol-A, epoxies of the phenol-novolac type, or epoxies based on tetrabromobisphenol-A reacted with (meth)acrylic acid or acrylamide monomers.

In some embodiments, the composition may further contain one or more additives selected from fillers, lubricants, surfactants, organic binders, polymeric binders, crosslinking agents, coupling agents, anti-dripping agents, fluoropolymers, heat and light stabilizers, antistatic agents, antioxidants, nucleating agents, carbodiimide, colorants, inks, dyes, UV absorbers and light stabilizers, 2-(2,′-hydroxyphenyl)-benzotriazoles, 2-hydroxybenzophenones, esters of optionally substituted benzoic acids, acrylates, nickel compounds, sterically hindered amines, oxalic acid diamides, metal deactivators, phosphites, phosphonites, compounds that destroy peroxide, basic costabilizers, nucleating agents, reinforcing agents, plasticizers, emulsifiers, pigments, optical brighteners, anti statics, blowing agents, and combinations thereof.

Some embodiments may relate to an article of manufacture containing the compound described above.

In some embodiments, the article may be selected from fibers, films, sheets, and molded articles.

Various embodiments of the present invention relate to a method for producing a cured polymer involving combining an unsaturated polyester, oligomeric phosphonate, oligomeric phosphate, or combinations thereof, and a cobalt-free catalyst system to form a reaction mixture; and curing the reaction mixture at room temperature.

In some embodiments, the curing occurs in less than about 60 minutes.

In some embodiments, the cobalt-free catalyst system may contain a transition metal-containing promoter selected from the group consisting of copper¹⁺ compounds, copper²⁺ compounds, iron²⁺ salts, iron³⁺ compounds, iron²⁺ salts, organic iron²⁺ salts, iron³⁺ salts, organic iron³⁺ salts, manganese²⁺ salts or complexes, manganese³⁺ salts or complexes, organic manganese²⁺ salts, organic manganese³⁺ salts, titanium compounds, and organotitanium compounds.

In some embodiments, the cobalt-free catalyst system may contain a transition metal-containing promoter selected from the group consisting of copper carboxylates, copper acetoacetates, copper chlorides, iron carboxylate, iron acetoacetate, manganese carboxylate, manganese acetoacetate, titanium alkoxidetitanium propoxide, titanium butoxide, titanium carboxylate, and combinations thereof.

In some embodiments, the oligomeric phosphonate may have a weight average molecular weight (Mw) of about 1,000 g/mole to about 18,000 g/mole, as determined by ηᵣₑₗ or GPC.

In some embodiments, the phosphonate component may have a number average molecular weight (Mn) of about 500 g/mole to about 10,000 g/mole.

In some embodiments, the phosphonate component may have a molecular weight distribution (Mw/Mn) of about 2 to about 7.

In some embodiments, the phosphonate component may have a relative viscosity of from about 1.01 to about 1.20.

In some embodiments, the phosphonate component may have a phosphorous content of about 1% to about 20% by weight.

In some embodiments, the oligomeric phosphonate may be of Formula I:

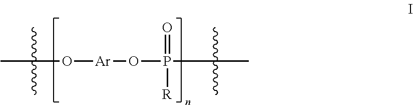

in which Ar is an aromatic group; —O-Ar-O— is derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations thereof; R is a C₁₋₂₀ alkyl, C₂₋₂₀ alkene, C₂₋₂₀ alkyne, C₅₋₂₀ cycloalkyl, or C₆₋₂₀ aryl; and n is an integer from 1 to about 20.

In some embodiments, the oligomeric phosphonate may be of Formula II:

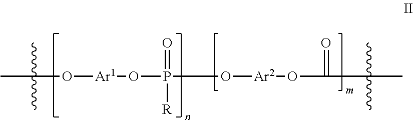

in which Ar¹ and Ar² are aromatic groups; each —O-Ar¹-O— and —O-Ar²—O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof; each R is, independently, C₁₋₂₀ alkyl, C₂₋₂₀ alkene, C₂₋₂₀ alkyne, C₅₋₂₀ cycloalkyl, or C₆₋₂₀ aryl; and each m and n is, independently, an integer from 1 to about 20.

In some embodiments, the oligomeric phosphonate may be of Formula III:

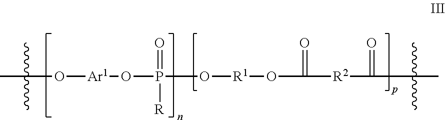

in which Ar¹ is an aromatic group; each —O-Ar¹-O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof; each R is, independently, C₁₋₂₀ alkyl, C₂₋₂₀ alkene, C₂₋₂₀ alkyne, C₅₋₂₀ cycloalkyl, or C₆₋₂₀ aryl; each R¹ and R² are, individually, aliphatic or aromatic hydrocarbons; and each n and p is, independently, an integer from 1 to about 20.

In some embodiments, the oligomeric phosphonate is selected from the group consisting of compounds of Formulae IV, V, and VI:

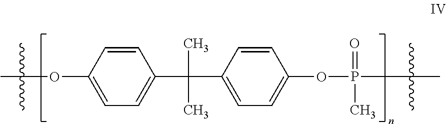

in which n is 1 to 20;

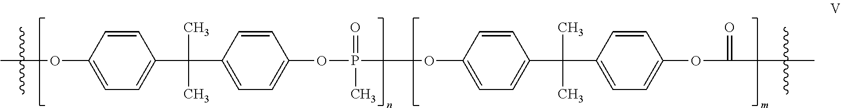

in which each n and m is, individually, 1 to 20; and

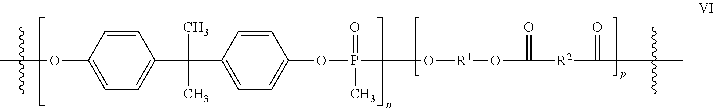

in which each n and p is, individually, 1 to 20.

In some embodiments, the compound may contain comprising about 10% to about 40% by weight oligomeric phosphonate.

In some embodiments, the oligomeric phosphate may be of Formula XIV:

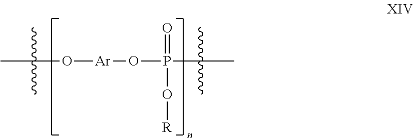

in which Ar is an aromatic group; —O-Ar-O— derived from resorcinol, hydroquinone, bisphenols, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of thereof; R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20.

In some embodiments, the oligomeric phosphates may have a weight average molecular weight (Mw) of about 300 g/mole to about 10,000 g/mole as determined by ηrel or GPC.

In some embodiments, the oligomeric phosphates may have a number average molecular weight (Mn) in such embodiments may be from about 500 g/mole to about 5000 g/mole.

In some embodiments, the oligomeric phosphate may be selected from trimethylphosphate, triethylphosphate, tripropylphosphate, tributylphosphate, tripentylphosphate, trihexylphosphate, tricyclohexylphosphate, triphenylphosphate, tricresylphosphate, trixylenylphosphate, dimethylethylphosphate, methyldibutylphosphate, ethyldipropylphosphate, and hydroxyphenyldiphenylphosphate.

In some embodiments, the composition may contain about 0.5 wt. % to about 15 wt. % oligomeric phosphate.

In some embodiments, the ratio of oligomeric phosphonate to oligomeric phosphate is about 10:1 to about 100:1.

In some embodiments, the unsaturated polyester may be selected from ortho-resins derived from phthalic anhydride, maleic anhydride, or fumaric acid and glycol, 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins derived from isophthalic acid, maleic anhydride or fumaric acid, and glycol, bisphenol-A-fumarates derived from bisphenol-A and fumaric acid, chlorendics derived from chlorine/bromine containing anhydrides or phenols, vinyl ester resins, vinyl ester resins containing epoxy resins, diglycidyl ether of bisphenol-A, epoxies of the phenol-novolac type, or epoxies based on tetrabromobisphenol-A reacted with (meth)acrylic acid or acrylamide monomers.

Various embodiments of the present invention relate to a composition containing a reactive solvent, an oligomeric phosphonate, and an acrylate.

In some embodiments, the reactive solvent may be selected from α-methyl styrene, (meth)acrylates, N-vinylpyrrolidone, N-vinylcaprolactam, and styrene.

In some embodiments, the acrylate may be selected from methyl methacrylate (MMA), ethyl methacrylate (EMA), butyl methacrylate (BMA), or 2-ethyl hexyl methacrylate (2-EHMA), or monomers such as, p-vinyltoluene, α-methyl styrene, diallyl phthalate, and triallyl cyanurate.

In some embodiments, the composition may contain about 20% to about 60% by weight oligomeric phosphonate.

In some embodiments, the oligomeric phosphonate may be selected from any of the various oligomeric phosphonates described above.

### DESCRIPTION OF THE DRAWINGS

In the following detailed description, reference is made to the accompanying drawings, which form a part hereof. In the drawings, similar symbols typically identify similar components unless context dictates otherwise. The illustrative embodiments described in the detailed description, drawings, and claims are not meant to be limiting. Other embodiments may be utilized and other changes may be made without departing from the spirit or scope of the subject matter presented herein. It will be readily understood that the aspects of the present disclosure, as generally described herein and illustrated in the Figures, can be arranged, substituted, combined, separated, and designed in a wide variety of different configurations, all of which are explicitly contemplated herein.

FIG. 1 is a graph showing gel time as a function of Nofia OL5000 concentration.

FIG. 2 is a graph comparing gel times of monomeric phosphate resorcinol diphenyl phosphate (RDP), a monomeric phosphonate diphenyl methyl phosphonate (DPP), Nofia OL5000, and dimeric phosphonate (Ecoflame P-1045/AMGUARD 1045) at 20 wt. % loading using the same catalyst system.

FIG. 3 is a plot showing gel time as a function of MEK-P concentration.

FIG. 4 is a plot showing gel time as a function of curing temperature from RT to 60° C. of compositions containing 20% Nofia OL5000.

FIG. 5 is a plot showing as a function of Mn catalyst concentration at various Nofia OL5000 concentrations.

FIG. 6 is a plot of gel time as a function of MEK-P concentration for compositions containing Nofia OL5000.

FIG. 7 is a plot of gel time for the composition containing Nofia OL5000 as a function of Nouryact CF12 concentration.

FIG. 8 is a plot of gel time as a function of MEK-P concentration.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

The term “aromatic diol” is meant to encompass any aromatic or predominately aromatic compound with at least two associated hydroxyl substitutions. In certain embodiments, the aromatic diol may have two or more phenolic hydroxyl groups. Examples of aromatic diols include, but are not limited to, 4,4′-dihydroxybiphenyl, hydroquinone, resorcinol, methyl hydroquinone, chlorohydroquinone, acetoxyhydroquinone, nitrohydroquinone, 1,4-dihydroxynaphthalene, 1,5-dihydroxynaphthalene, 1,6-dihydroxynaphthalene, 2,6-dihydroxynaphthalene, 2,7-dihydroxynaphthalene, 2,2-bis(4-hydroxyphenyl)propane, 2,2-bis(4-hydroxy-3,5-dimethylphenyl)propane, 2,2-bis(4-hydroxy-3,5-dichlorophenyl)propane, 2,2-bis(4-hydroxy-3-methylphenyl)propane, 2,2-bis(4-hydroxy-3-chlorophenyl)propane, bis(4-hydroxyphenyl)methane, bis(4-hydroxy-3,5-dimethylphenyl)methane, bis(4-hydroxy-3,5-dichlorophenyl)methane, bis(4-hydroxy-3,5-dibromophenyl)methane, bis(4-hydroxy-3-methylphenyl)methane, bis(4-hydroxy-3-chlorophenyl)methane, 1,1-bis(4-hydroxyphenyl)cyclohexane, bis(4-hydroxyphenyl)ketone, bis(4-hydroxy-3, 5-dimethylphenyl)ketone, bis(4-hydroxy-3,5-dichlorophenyl)ketone, bis(4-hydroxyphenyl) sulfide bis(4-hydroxyphenyl) sulfone, phenolphthalein or phenolphthalein derivatives, 4,4′-thiodiphenol, 4,4′-sulfonyldiphenol, 4,4,-dihydroxydiphenylether, and 1,1-bis-(4-hydroxyphenyl)-3,3,5-trimethylcyclohexane. In some embodiments, a single aromatic diol may be used, and in other embodiments, various combinations of such aromatic diols may be incorporated into the polyester.

The term “alkyl” or “alkyl group” refers to a branched or unbranched hydrocarbon or group of 1 to 20 carbon atoms, such as but not limited to methyl, ethyl, n-propyl, isopropyl, n-butyl, isobutyl, t-butyl, octyl, decyl, tetradecyl, hexadecyl, eicosyl, tetracosyl and the like. “Cycloalkyl” or “cycloalkyl groups” are branched or unbranched hydrocarbons in which all or some of the carbons are arranged in a ring such as but not limited to cyclopentyl, cyclohexyl, methylcyclohexyl and the like. The term “lower alkyl” includes an alkyl group of 1 to 10 carbon atoms.

The term “aryl” or “aryl group” refers to monovalent aromatic hydrocarbon radicals or groups consisting of one or more fused rings in which at least one ring is aromatic in nature. Aryls may include but are not limited to phenyl, napthyl, biphenyl ring systems and the like. The aryl group may be unsubstituted or substituted with a variety of substituents including but not limited to alkyl, alkenyl, halide, benzylic, alkyl or aromatic ether, nitro, cyano, and the like and combinations thereof.

“Substituent” refers to a molecular group that replaces a hydrogen in a compound and may include but is not limited to trifluoromethyl, nitro, cyano, C₁-C₂₀ alkyl, aromatic or aryl, halide (F, Cl, Br, I), C₁-C₂₀ alkyl ether, C₁-C₂₀ alkyl ester, benzyl halide, benzyl ether, aromatic or aryl ether, hydroxy, alkoxy, amino, alkylamino (—NHR′), dialkylamino NR′R″) or other groups which do not interfere with the formation of the intended product.

As defined herein, an “arylol” or an “arylol group” is an aryl group with a hydroxyl, OH substituent on the aryl ring. Non-limiting examples of an arylol are phenol, naphthol, and the like. A wide variety of arlyols may be used in the embodiments of the invention and are commercially available.

The term “alkanol” or “alkanol group” refers to a compound including an alkyl of 1 to 20 carbon atoms or more having at least one hydroxyl group substituent. Examples of alkanols include but are not limited to methanol, ethanol, 1- and 2-propanol, 1,1-dimethylethanol, hexanol, octanol and the like. Alkanol groups may be optionally substituted with substituents as described above.

The term “alkenol” or “alkenol group” refers to a compound including an alkene 2 to 20 carbon atoms or more having at least one hydroxyl group substituent. The hydroxyl may be arranged in either isomeric configuration (cis or trans). Alkenols may be further substituted with one or more substituents as described above and may be used in place of alkenols in some embodiments of the invention. Alkenols are known to those skilled in the art and many are readily available commercially.

As used herein, the term “about” means plus or minus 10% of the numerical value of the number with which it is being used. Therefore, about 50% means in the range of 45%-55%.

A “flame retardant” refers to any compound that inhibits, prevents, or reduces the spread of fire.

The terms “flame retardant,” “flame resistant,” “fire resistant,” or “fire resistance,” as used herein, mean that the composition exhibits a limiting oxygen index (LOI) of at least 27. “Flame retardant,” “flame resistant,” “fire resistant,” or “fire resistance” may also refer to the flame reference standard ASTM D6413-99 for textile compositions, flame persistent test NF P 92-504, and similar standards for flame resistant fibers and textiles. Fire resistance may also be tested by measuring the after-burning time in accordance with the UL test (Subject 94). In this test, the tested materials are given classifications of UL-94 V-0, UL-94 V-1 and UL-94 V-2 on the basis of the results obtained with the ten test specimens. Briefly, the criteria for each of these UL-94-V-classifications are as follows:

UL-94 V-0: the maximum burning time after removal of the ignition flame should not exceed 10 seconds and the total burning time (t1+t2) for five tested specimens should not exceed 50 seconds. None of the test specimens should release any drips which ignite absorbent cotton wool.

UL-94 V-1: the maximum burning time after removal of the ignition flame should not exceed 30 seconds and the total burning time (t1+t2) for five tested specimens should not exceed 250 seconds. None of the test specimens should release any drips which ignite absorbent cotton wool.

UL-94 V-2: the maximum burning time after removal of the ignition flame should not exceed 30 seconds and the total burning time (t1+t2) for five tested specimens should not exceed 250 seconds. The test specimens may release flaming particles, which ignite absorbent cotton wool.

Fire resistance may also be tested by measuring after-burning time. These test methods provide a laboratory test procedure for measuring and comparing the surface flammability of materials when exposed to a prescribed level of radiant heat energy to measure the surface flammability of materials when exposed to fire. The test is conducted using small specimens that are representative, to the extent possible, of the material or assembly being evaluated. The rate at which flames travel along surfaces depends upon the physical and thermal properties of the material, product or assembly under test, the specimen mounting method and orientation, the type and level of fire or heat exposure, the availability of air, and properties of the surrounding enclosure. If different test conditions are substituted or the end-use conditions are changed, it may not always be possible by or from this test to predict changes in the fire-test-response characteristics measured. Therefore, the results are valid only for the fire test exposure conditions described in this procedure.

Fire resistance may also be tested by measuring heat release properties. These test methods measure heat release rate as a function of time and report total heat release rate, peak heat release rate, ignition time, but also CO, CO₂, and smoke release. An improved fire resistance would mean an increase in ignition time or a reduction in one or more of these other variables.

The state-of-the-art approach to rendering polymers flame retardant is to use additives such as brominated compounds or compounds containing aluminum and/or phosphorus. Some of these compounds are toxic, and can leach into the environment over time, making their use less desirable. In some countries, certain brominated additives are being phased out of use because of environmental concerns.

The term “toughness,” as used herein, is meant to imply that the material is resistant to breaking or fracturing when stressed or impacted. There are a variety of standardized tests available to determine the toughness of a material. Generally, toughness is determined qualitatively using a film or a molded specimen.

“Number averaged molecular weight” can be determined by relative viscosity (ηᵣₑₗ) and/or gel permeation chromatography (GPC). Unless otherwise indicated, the values recited are based on polystyrene standards. Relative viscosity (ηᵣₑₗ) is a measurement that is indicative of the molecular of weight of a polymer and is generally measured by dissolving a known quantity of polymer in a solvent and comparing the time it takes for this solution and the neat solvent to travel through a capillary (i.e., viscometer) at a constant temperature. It is also well known that a low relative viscosity is indicative of a low molecular weight polymer. Low molecular weight may cause mechanical properties such as strength and toughness to be worse compared to higher molecular weight samples of the same polymers. Therefore, reducing the relative viscosity of a polymer would be expected to result in a reduction in mechanical properties, for example, poor strength or toughness compared to the same composition which has a higher relative viscosity.

GPC is a type of chromatography that separates polymers by size. This technique provides information about the molecular weight and molecular weight distribution of the polymer, i.e., the polydispersity index (PDI).

Various embodiments of the invention are directed to methods for producing flame retardant polyester resins that provide improved processing at room temperature (via significant reduction of gel times). In such embodiments, cobalt-free or substantially cobalt-free transition metal-containing promoters are used in combination with organic peroxides. This enables room temperature processing of flame retardant unsaturated polyester systems containing oligomeric phosphates or phosphonates.

The methods of various embodiments may include the steps of combining unsaturated polyester (UPET) and an oligomeric phosphate or oligomeric phosphonate to form a reaction mixture and introducing a cobalt-free or substantially cobalt-free transition metal-containing promoter and an organic peroxide to the mixture and curing the reaction mixture. In some embodiments, curing can be carried out at room temperature. In particular embodiments, the mixture may further include a reactive solvent such as styrene, and in some embodiments, the method may include the step of dissolving the oligomeric phosphate or oligomeric phosphonate in a reactive solvent before combining the oligomeric phosphate or oligomeric phosphonate with the unsaturated polyester. In such embodiments, curing may occur at room temperature (about 20° C. to about 25° C.) in less than about 60 minutes or less than about 30 minutes, and in certain embodiments, less than about 20 minutes of combining the components of the mixture.

The concentration of oligomeric phosphate or oligomeric phosphonate in the mixture may be up to about 30% or about 40% by weight. For example, in various embodiments, the weight concentration of oligomeric phosphate or oligomeric phosphonate may be from about 10% to about 40%, about 15% to about 35%, about 20% to about 35%, or any individual value or range encompassed by these example ranges.

When dissolved in a reactive solvent, the weight concentration of oligomeric phosphate or oligomeric phosphonate may be up to about 50% or about 60% in the reactive solvent, oligomeric phosphate or oligomeric phosphonate mixture before being combined with UPET to provide sufficient oligomeric phosphate or oligomeric phosphonate to produce a final concentration of oligomeric phosphate or phosphonate of up to about 30% or about 40% by weight as described above. Examples of reactive solvents include α-methylstyrene, (meth)acrylates, N-vinylpyrrolidone, and N-vinylcaprolactam, and in particular embodiments, the reactive solvent may be styrene. The weight concentration of oligomeric phosphate or oligomeric phosphonate in the reactive solvent, oligomeric phosphate or oligomeric phosphonate mixture may be about 20% to about 60%, about 25% to about 50%, about 30% to about 45% or any range or individual concentration or range encompassed by these example ranges.

In some embodiments, the solution of dissolved oligomeric phosphate or oligomeric phosphonate in a reactive solvent may further include an acrylate monomer such as, for example, methyl methacrylate (MMA), ethyl methacrylate (EMA), butyl methacrylate (BMA), or 2-ethyl hexyl methacrylate (2-EHMA), or monomers such as, p-vinyltoluene, α-methyl styrene, diallyl phthalate, or triallyl cyanurate. The additional monomers may improve the solubility and stability of the mixture of reactive solvent, and oligomeric phosphate or oligomeric phosphonate in UPET resin. For example, compositions containing additional monomers may have a shelf-like at room temperature up to about 3 months or, in some embodiments, up to about 6 months. The weight concentration of acrylate monomer incorporated into the styrene, oligomeric phosphate or oligomeric phosphonate mixture may be up to about 5%. For example, in some embodiments, the weight concentration of acrylate monomer may be from about 0.1% to about 5%, about 0.5% to about 4%, about 0.75% to about 2% or any range or individual value encompassed by these example ranges.

The step of dissolving the oligomeric phosphate or oligomeric phosphonate in a reactive solvent may be carried out immediately before combining with UPET in order to reduce the dissolution time of the oligomeric phosphate or oligomeric phosphonate in the UPET resin. Such compositions may include oligomeric phosphate or oligomeric phosphonate in a reactive solvent and one or more acrylic monomers. In other embodiments, the step of dissolving the oligomeric phosphate or oligomeric phosphonate in reactive solvent may be carried out for a time period of hours, days, or weeks before combining with UPET. In certain embodiments, oligomeric phosphate or oligomeric phosphonate that are dissolved in reactive solvent before being combined with UPET may further include one or more acrylic monomers.

In particular embodiments, the oligomeric phosphonate can be used in powder form instead of pellets, which enhances the dissolution time of the oligomeric phosphonate in the UPET resin and reactive solvent mixture. In such embodiments, particle size of the oligomeric phosphonate powder can be from about 50 microns to about 500 microns, and in some embodiments, the powder can have an average particle size of about 75 microns to about 150 microns.

The UPET resins encompassed by the invention include any unsaturated polyester or vinyl ester resins known in the art. For example, UPETs include ortho-resins based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins prepared from isophthalic acid, maleic anhydride or fumaric acid, and glycols, bisphenol-A-fumarates derived from bisphenol-A and fumaric acid, chlorendics prepared from chlorine/bromine containing anhydrides or phenols, and vinyl ester resins which can be prepared from epoxy resins such as, for example, diglycidyl ether of bisphenol-A, epoxies of the phenol-novolac type, or epoxies based on tetrabromobisphenol-A reacted with (meth)acrylic acid or acrylamide monomers. Vinyl ester resins may provide improved hydrolytic resistance and excellent mechanical properties, as well as low styrene emission. In some embodiments, the UPET may be a vinyl ester urethane resin obtained by the esterification of an epoxy resin with an acrylic acid or acrylamide monomers. In some embodiments, the resins described above may be modified to, for example, achieve lower acid number, lower hydroxyl number or anhydride number, or by introducing flexible units in the backbone.

The transition metal-containing promoter can vary among embodiments and can include any transition metal-containing promoter known in the art. For example, the transition metal-containing promoter may include a variety of transition metals including copper, iron, manganese, or titanium. In various embodiments, the transition metal-containing promoter can be substantially free of cobalt meaning the concentration of cobalt may be less than 0.001 mmol of cobalt per kg of UPET resin. In particular embodiments, the transition metal-containing promoter may be completely free of cobalt.

In some embodiments, the transition metal-containing promoter may be a copper compound. Such copper compounds may be a copper¹⁺ or copper²⁺ compound including, for example, copper carboxylates, copper acetoacetates, copper chlorides, or combinations thereof. In some embodiments, the transition metal-containing promoter may be an iron compound. Such iron-containing compounds may be iron²⁺ salt or a iron³⁺ compounds including iron²⁺ salt, organic iron²⁺ salt, iron³⁺ salt or organic iron³⁺ salt. In particular embodiments, the iron compounds may be iron carboxylate, iron acetoacetate, or combinations thereof. In some embodiments, the transition metal-containing promoter may be a manganese compound such as a manganese²⁺ salt or complex or a manganese³⁺ salt or complex, including organic manganese²⁺ salts and organic manganese³⁺ salts such as manganese carboxylate, manganese acetoacetate, or combinations thereof. In further embodiments, the transition metal-containing promoter may be a titanium compound or organotitanium compound such as, for example, titanium alkoxide, titanium propoxide, titanium butoxide, titanium carboxylate, and combinations thereof.

The transition metal-containing promoter can be present in the resin composition in an amount of about 0.05 mmol per kg of resin or more. For example, the amount of transition metal-containing promoter may be from about 0.05 mmol per kg of resin to about 50 mmol per kg of resin, or about 1.0 mmol per kg of resin to about 20 mmol per kg of resin.

The peroxide component can be any peroxide known in the art. Such peroxides include any organic and inorganic peroxides such as, for example, peroxy carbonates (—OC(O)O—), peroxyesters (—C(O)OO—), diacylperoxides (—C(O)OOC(O)—), dialkylperoxides (—OO—), and the like and combinations thereof. Particular examples of suitable organic peroxides include, but are not limited to, tertiary alkyl hydroperoxides (such as, t-butyl hydroperoxide), other hydroperoxides (such as cumene hydroperoxide), ketone peroxides (such as, for instance, methyl ethyl ketone peroxide, methyl isobutyl ketone peroxide, and acetylacetone peroxide), peroxyesters or peracids (such as t-butyl peresters, benzoyl peroxide, peracetates, and perbenzoates, lauryl peroxide, including (di)peroxyesters), -perethers (such as, peroxy diethyl ether), tertiary peresters or tertiary hydroperoxides, i.e. peroxy compounds having tertiary carbon atoms directly united to an —OO-acyl or —OOH group. Such peroxides may be mixed, i.e. peroxides containing any two of different peroxygen-bearing moieties in one molecule. In case a solid peroxide is being used for the curing, the peroxide is preferably benzoyl peroxide (BPO). In certain embodiments, the peroxide may be selected from the group of ketone peroxides, and in some embodiments, the peroxide may be methyl ethyl ketone peroxide.

The peroxide component may be incorporated into the reaction mixture in any amount sufficient to provide adequate activity. For example, in some embodiments, the reaction mixture may include about 0.1 wt. % to about 10 wt. % peroxide component, and in other embodiments, the reaction mixture may include about 0.2 wt. % to about 8 wt. %, about 0.5 wt. % to about 5 wt. %, or any range or individual concentration encompassed by these example ranges.

The oligomeric phosphonates may include polyphosphonates, random copolyphosphonates, oligophosphonates, co-oligo(phosphonate ester)s, or co-oligo(phosphonate carbonate)s, and in certain embodiments, the phosphonate component may have the structures described and claimed in U.S. Pat. Nos. 6,861,499, 7,816,486, 7,645,850, 7,838,604, 8,415,438, 8,389,664, 8,648,163, 8,563,638, 8,779,041, 8,530,044, and U.S. Publication No. 2009/0032770, each of which is hereby incorporated by reference in its entirety.

Such oligomeric phosphonates may include repeating units derived from diaryl alkylphosphonates or diaryl arylphosphonates. For example, in some embodiments, such oligomeric phosphonates include structural units illustrated by Formula I:

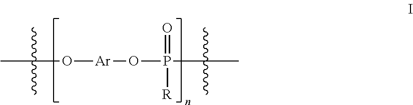

where Ar is an aromatic group and —O-Ar-O— may be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₀₂₀ alkyne, C₅₋₂₀ cycloalkyl, or C₆₋₂₀ aryl, and n is an integer from 1 to about 20, 1 to about 10, or 2 to about 5, or any integer between these ranges.

In some embodiments, the oligomeric phosphonates may have a weight average molecular weight (Mw) of about 1,000 g/mole to about 18,000 g/mole as determined by ηᵣₑₗ or GPC, and in other embodiments, the oligomeric phosphonates may have an Mw of from about 1,000 to about 15,000 g/mole as determined by ηᵣₑₗ or GPC. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole. The narrow molecular weight distribution (i.e., Mw/Mn) of such oligomeric phosphonates may be from about 2 to about 7 in some embodiments and from about 2 to about 5 in other embodiments. In still other embodiments, the oligomeric phosphonates may have a relative viscosity of from about 1.01 to about 1.20.

In some embodiments, the oligomeric phosphonates may be a random copoly(phosphonate carbonate). These random copoly(phosphonate carbonate)s may include repeating units derived from at least 20 mole percent high-purity diaryl alkylphosphonate or optionally substituted diaryl alkylphosphonate, one or more diaryl carbonate, and one or more aromatic dihydroxides, wherein the mole percent of the high-purity diaryl alkylphosphonate is based on the total amount of transesterification components, i.e., total diaryl alkylphosphonate and total diaryl carbonate. As indicated by the term “random,” the monomers of the copoly(phosphonate carbonate)s of various embodiments are incorporated into the polymer chain randomly. Therefore, the polymer chain may include alternating phosphonate and carbonate monomers linked by an aromatic dihydroxide and/or various segments in which several phosphonate or several carbonate monomers form oligophosphonate or polyphosphonate or oligocarbonate or polycarbonate segments. Additionally, the length of various oligo or polyphosphonate oligo or polycarbonate segments may vary within individual copoly(phosphonate carbonate)s.

The phosphonate and carbonate content of the copoly(phosphonate carbonate)s may vary among embodiments, and embodiments are not limited by the phosphonate and/or carbonate content or range of phosphonate and/or carbonate content. For example, in some embodiments, the copoly(phosphonate carbonate)s may have a phosphorus content, which is indicative of the phosphonate content of from about 1% to about 20% by weight of the total copoly(phosphonate carbonate), and in other embodiments, the phosphorous content of the copoly(phosphonate carbonate)s of the invention may be from about 2% to about 10% by weight of the total polymer.

The co-oligo(phosphonate carbonate)s of various embodiments exhibit both a high molecular weight and a narrow molecular weight distribution (i.e., low polydispersity). For example, in some embodiments, the co-oligo(phosphonate carbonate)s may have a weight average molecular weight (Mw) of about 1,000 g/mole to about 18,000 g/mole as determined by ηᵣₑₗ or GPC, and in other embodiments, the co-oligo(phosphonate carbonate)s may have an Mw of from about 1,000 to about 15,000 g/mole as determined by ηᵣₑₗ or GPC. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole. The narrow molecular weight distribution (i.e., Mw/Mn) of such co-oligo(phosphonate carbonate)s may be from about 2 to about 7 in some embodiments and from about 2 to about 5 in other embodiments. In still other embodiments, the co-oligo(phosphonate carbonate)s may have a relative viscosity of from about 1.01 to about 1.20.

In other embodiments, the co-oligo(phosphonate carbonate)s, or co-oligo(phosphonate ester)s, may have structures such as, but not limited to, those structures of Formulae II and III, respectively:

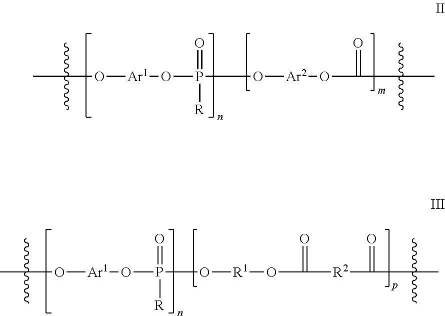

and combinations thereof, where Ar, Ar¹, and Ar² are each, independently, an aromatic group and —O-Ar-O— may be derived from a dihydroxy compound having one or more, optionally substituted aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, R¹ and R² are aliphatic or aromatic hydrocarbons, and each m, n, and p can be the same or different and can, independently, be an integer from 1 to about 20, 1 to about 10, or 2 to about 5, or any integer between these ranges. In certain embodiments, each m, n and p are about equal and generally greater than 5 or less than 15.

As indicated by the term “random,” the monomers of the “random co-oligo(phosphonate carbonate)s” or “random co-oligo(phosphonate ester)s” of various embodiments are incorporated into the polymer chain randomly, such that the oligomeric phosphonate chain can include alternating phosphonate and carbonate or ester monomers or short segments in which several phosphonate or carbonate or ester monomers are linked by an aromatic dihydroxide. The length of such segments may vary within individual random co-oligo(phosphonate carbonate)s or co-oligo(phosphonate ester)s.

In particular embodiments, the Ar, Ar¹, and Ar² may be derived from bisphenol A, and R may be a methyl group providing polyphosphonates, oligomeric phosphonates, random and block co-oligo(phosphonate carbonate)s and co-oligo(phosphonate ester)s having reactive end-groups. Such compounds may have structures such as, but not limited to, structures of Formulae IV, V, and VI:

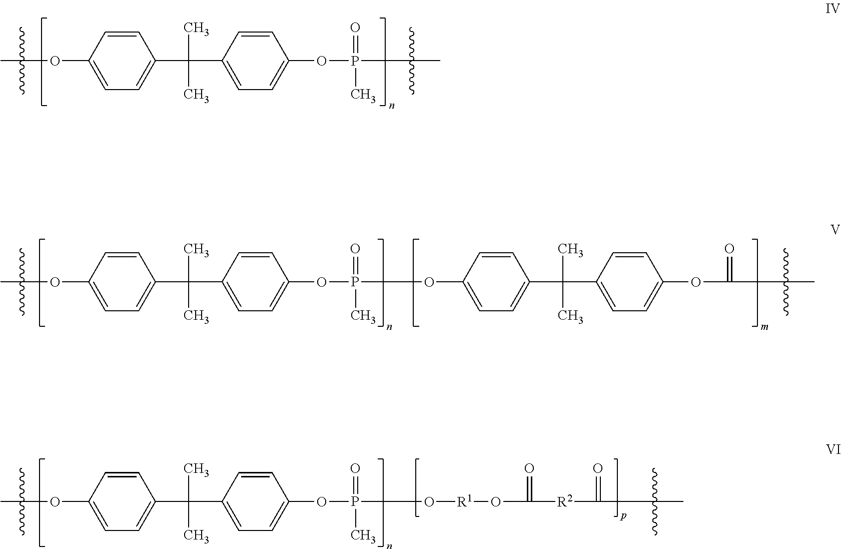

and combinations thereof, where each of m, n, p, and R¹ and R² is defined as described above. Such co-oligo(phosphonate ester)s, or co-oligo(phosphonate carbonate)s may be block co-oligo(phosphonate ester), block co-oligo(phosphonate carbonate) in which each m, n, and p is greater than about 1, and the copolymers contain distinct repeating phosphonate and carbonate blocks or phosphonate and ester blocks. In other embodiments, the oligomeric co-oligo(phosphonate ester)s or co-oligo(phosphonate carbonate)s can be random copolymers in which each m, n, and p can vary and may be from n is an integer from 1 to about 30, from 1 to about 20, 1 to about 10, or 2 to about 5, where the total of m, n, and p is an integer from 1 to about 20, 1 to about 10, or 2 to about 5, or any integer between these ranges.

In some embodiments, bisphenol A may be the only (i.e., 100%) bisphenol used in the preparation of the phosphonate component. In other embodiments, bisphenol A may make up about 5% to about 90%, about 10% to about 80%, about 20% to about 70%, about 30% to about 60%, about 40% to about 50%, or a value between any of these ranges, with the remainder being another bisphenol such as any one or more of the bisphenols described above.

The phosphorous content of oligomeric phosphonates may be controlled by the molecular weight (MW) of the bisphenol used in the oligomeric phosphonates, polyphosphonates, copolyphosphonates, or co-oligophosphonates. A lower molecular weight bisphenol may produce an oligomeric phosphonate or copolyphosphonate with a higher phosphorus content. Bisphenols, such as resorcinol, hydroquinone, or a combination thereof or similar low molecular weight bisphenols may be used to make oligomeric phosphonates or polyphosphonates with high phosphorous content. The phosphorus content, expressed in terms of the weight percentage, of the phosphonate oligomers, phosphonates, copolyphosphonates, or co-oligophosphonates may be in the range from about 2% to about 18%, about 4% to about 16%, about 6% to about 14%, about 8% to about 12%, or a value between any of these ranges. In some embodiments, phosphonate oligomers, polyphosphonates, copolyphosphonates, or co-oligophosphonates prepared from bisphenol A or hydroquinone may have phosphorus contents of 10.8% and 18%, respectively. The phosphonate copolymers have a smaller amount of phosphorus content compared to the phosphonate oligomers and the polyphosphonates. In some embodiments, a bisphenol A-based copolyphosphonate containing phosphonate and carbonate components wherein the phosphonate component is derived from the methyl diphenylphosphonate at a concentration of 20% compared to the total of the phosphonate and carbonate starting components may have about 2.30% phosphorus, about 2.35% phosphorus, about 2.38% phosphorus, about 2.40% phosphorus, or a range between any of these values, including endpoints.

With particular regard to co-oligo(phosphonate ester)s, co-oligo(phosphonate carbonate)s, block co-oligo(phosphonate ester)s, and block co-oligo(phosphonate carbonate)s, without wishing to be bound by theory, oligomers containing carbonate components, whether as carbonate blocks or randomly arranged carbonate monomers, may provide improved toughness over oligomers derived solely from phosphonates. Such co-oligomers may also provide a higher glass transition temperature, T_{g}, and better heat stability over phosphonate oligomers.

The co-oligo(phosphonate carbonate)s of certain embodiments may be synthesized from at least 20 mole % diaryl alkylphosphonate or optionally substituted diaryl alkylphosphonate, one or more diaryl carbonate, and one or more aromatic dihydroxide, wherein the mole percent of the high-purity diaryl alkylphosphonate is based on the total amount of transesterification components, i.e., total diaryl alkylphosphonate and total diaryl carbonate. Likewise, co-oligo(phosphonate ester)s of certain embodiments may be synthesized from at least 20 mole % diaryl alkylphosphonate or optionally substituted diaryl alkylphosphonate, one or more diaryl esters, and one or more aromatic dihydroxides, wherein the mole percent of the diaryl alkylphosphonate is based on the total amount of transesterification components.

The phosphonate and carbonate content of the oligomeric phosphonates, random or block co-oligo(phosphonate carbonate)s and co-oligo(phosphonate ester)s may vary among embodiments, and embodiments are not limited by the phosphonate and/or carbonate content or range of phosphonate and/or carbonate content. For example, in some embodiments, the co-oligo(phosphonate carbonate)s or co-oligo(phosphonate ester)s may have a phosphorus content of from about 1% to about 12% by weight of the total oligomer. In other embodiments, the phosphorous content may be from about 2% to about 10% by weight of the total oligomer.

In some embodiments, the molecular weight (weight average molecular weight as determined by gel permeation chromatography based on polystyrene calibration) range of the oligophosphonates, random or block co-oligo(phosphonate ester)s and co-oligo(phosphonate carbonate)s may have a weight average molecular weight (Mw) of about 1,000 g/mole to about 18,000 g/mole as determined by ηᵣₑₗ or GPC, and in other embodiments, the oligomeric phosphonates may have an Mw of from about 1,000 to about 15,000 g/mole as determined by ηᵣₑₗ or GPC. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole.

Hyperbranched oligomers of various embodiments have a highly branched structure and a high degree of functionality (i.e., chemical reactivity). The branched structure of such hyperbranched oligomers creates a high concentration of terminal groups, one at the end of nearly every branch that can include a reactive functional group such as hydroxyl end groups, epoxy end groups, vinyl end groups, vinyl ester end groups, isopropenyl end groups, isocyanate end groups, and the like. In some embodiments, the hyperbranched oligomers may have a unique combination of chemical and physical properties when compared to linear oligomeric phosphonates. For example, the high degree of branching can prevent crystallization and can render chain entanglement unlikely, so the hyperbranched oligomers can exhibit solubility in organic solvents and low solution viscosity and low melt viscosity, especially when sheared.

In some embodiments, the hyperbranched oligomers can contain branches that are not perfectly (i.e., absolutely regularly) arranged. For example, various branches on a single hyperbranched oligomer may have different lengths, functional group composition, and the like, and combinations thereof. Consequently, in some embodiments, the hyperbranched oligomers of the invention can have a broad molecular weight distribution. In other embodiments, the hyperbranched oligomers of the invention may be perfectly branched, including branches that are nearly identical, and have a monodisperse molecular weight distribution.

The degree of branching for the hyperbranched oligomers of the invention can be defined as the number average fraction of branching groups per molecule, i.e., the ratio of terminal groups plus branch monomer units to the total number of terminal groups, branch monomer units, and linear monomer units. For linear oligomers, the degree of branching as defined by the number average fraction of branching groups per molecule is zero, and for ideal dendrimers, the degree of branching is one. Hyperbranched oligomers can have a degree of branching which is intermediate between that of linear oligomers and ideal dendrimers. For example, a degree of branching for hyperbranched oligomers may be from about 0.05 to about 1, about 0.25 to about 0.75, or about 0.3 to about 0.6. In certain embodiments, the hyperbranched oligomers may have a number average fraction of branching groups of about 0.5.

The hyperbranched oligomers of the invention may be generically represented by the following structure Formula VII:

B_{w}L-Fᵥ VII

where B is the hyperbranched oligomer and w is the number of branches, v is an integer that is not zero, L is a linking group, and F is a reactive group.

The linking group (L) can be any moiety compatible with the chemistry of the monomers for the oligophosphonate, co-oligo(phosphonate ester), or co-oligo(phosphonate carbonate) described above. For example, in some embodiments, L can be any unit derived from an aryl or heteroaryl group including single aryl groups, biaryl groups, triaryl groups, tetraaryl groups, and so on. In other embodiments, L can be a covalent bond linking a functional group (F) directly to the hyperbranched oligomer, and in still other embodiments, L can be a C₁-C₁₀ alkyl, C₂-C₁₀ alkene, or C₂-C₁₀ alkyne that may or may not be branched.

The linking group (L) allows for the attachment of one or more functional groups (F) to each branch termination of the hyperbranched oligomer. In some embodiments, each branch termination may have an attached linking group, and in other embodiments, one or more branch terminations of the hyperbranched oligomer (B) may not have an attached linking group. Such branch terminations without an attached linking group may terminate in a hydroxyl group or phenol group associated with the monomeric units of the hyperbranched oligomer. For branch terminations that include a linking group (L), each linking group may have from 0 to 5 or more associated functional groups. Thus, in some embodiments, one or more linking groups of the reactive hyperbranched oligomer may have no attached functional groups, such that the branch termination associated with this linking group is substantially unreactive. In other embodiments, one or more linking groups of the reactive hyperbranched oligomer may have one or more attached functional groups providing a branch termination that is potentially reactive with other monomers, oligomers, or polymers. In still other embodiments, one or more linking groups of the reactive hyperbranched oligomer can have multiple attached functional groups. For example, two of the aryl groups associated with a triaryl group may include a functional group (F) with the third aryl group attaching the linking group to the hyperbranched polymer or oligomer. The functional group (F) may vary among embodiments and can be any chemical moiety capable of reacting with another chemical moiety. Non-limiting examples of functional groups (F) include hydroxyl, carboxylic acid, amine, cyanate, isocyanate, epoxy, glycidyl ether, vinyl, and the like, and combinations thereof. The reactive hyperbranched oligomers are reactive with a variety of functional groups such as epoxies, anhydrides, activated halides, carboxylic acids, carboxylic esters, isocyanates, aldehydes, vinyls, acetylenes, and silanes. These groups may be present on another monomer, oligomer, or polymer used in the preparation of a polymer composition.

The hyberbranched oligomer portion (B) of the general structure presented above may be any phosphonate-containing hyperbranched oligomer. For example, in some embodiments, such hyperbranched oligomers may include repeating units derived from diaryl alkyl- or diaryl arylphosphonates, and in certain embodiments, such hyperbranched oligomers may have a structure including units of Formula I:

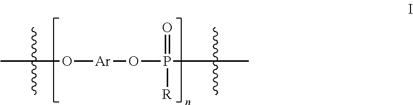

where Ar is an aromatic group and —O-Ar-O— may be derived from a compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges.

The hyperbranched oligomers (B) of such embodiments may further include units derived from branching agents or multifunctional aryl multifunctional biaryl groups, multifunctional triaryl groups, multifunctional tetraaryl groups, and so on. In some embodiments, the units derived from branching agents may be derived from, for example, polyfunctional acids, polyfunctional glycols, or acid/glycol hybrids. In other embodiments, the hyperbranched oligomeric phosphonates may have units derived from tri or tetrahydroxy aromatic compounds or triaryl or tetraaryl phosphoric acid esters, triaryl or tetraaryl carbonate or triaryl or tetraaryl esters, or combinations thereof such as, but not limited to, trimesic acid, pyromellitic acid, trimellitic anhydride, pyromellitic anhydride, trimethylolpropane, dimethyl hydroxyl terephthalate, pentaerythritol, and the like, and combinations thereof. Such branching agents provide branch points within the hyperbranched oligomeric phosphonate. In particular embodiments, the branching agent may be a triaryl phosphate such as, for example, those of Formula VIII:

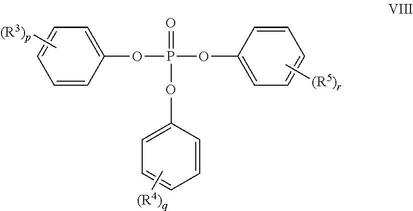

where each R³, R⁴, and R⁵ can, independently, be a hydrogen, C₁-C₄ alkyl of, and each of p, q, and r is independently an integer of from 1 to 5.

The number of branches (w) may be directly proportional to the number of units derived from a branching agent and may be any integer from about 2 to about 20. In some embodiments, n may be an integer greater than 3, greater than 5, or greater than 10, or any value within these ranges. In other embodiments, n may be from about 5 to about 20, about 5 to about 15, about 5 to about 10, or any value between these ranges.

The reactive hyperbranched phosphonates of certain embodiments may have a structure in which B is of Formula IX or Formula X:

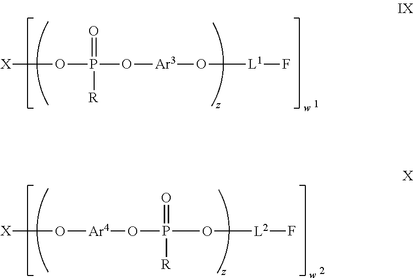

where Ar³ and Ar⁴ are, independently, an aromatic group and —O-Ar³-O— and —O-Ar⁴-O— can be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, L¹ and L² are, independently, a covalent bond or an aryl or heteroaryl group including single aryl groups, biaryl groups, triaryl groups, tetraaryl groups, and so on, R can be a C₁₋₂₀ alkyl, C₂₋₂₀ alkene, C₂₋₂₀ alkyne, C₅₋₂₀ cycloalkyl, or C₆₋₂₀ aryl, z is an integer from 1 to about 30, 1 to about 20, 1 to about 10, or 2 to about 5, or any integer between these ranges, and w¹ and w² are, independently, 1 to 5. X may be derived from any branching agent described above. In some embodiments, X in an individual B may be the same molecule, such that branches having a structure of Formula VII and Formula VII may extend from the same branching agent (X) molecule. In particular embodiments, X may be a triarylphosphate of Formula VIII as described above. In other embodiments, two or more X may be linked as illustrated in Formula XI, Formula XII, or Formula XIIII:

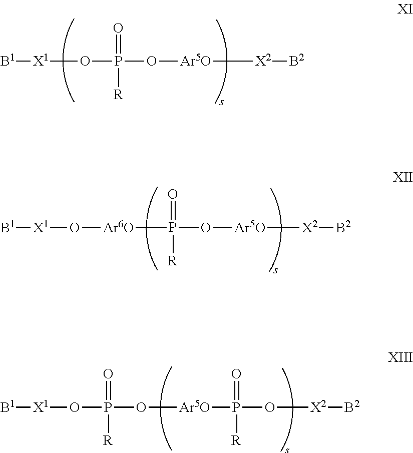

where B¹ and B² are, independently, hyperbranched polymers as described above, X¹ and X² are, independently, branching agents as described above, Ar^{y} and Ar⁶ are, independently, aromatic groups and —O-Ar⁵-O— and —O-Ar⁶-O— can be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane or combinations of these, each R is as defined as above, and s is an integer of from 1 to about 30, 1 to about 20, 1 to about 10, or 2 to about 5, or any integer therebetween. In various embodiments, an individual reactive hyperbranched oligomer may have a structure in which portions of the oligomer can be any of Formula I, and VIII to XIII. Thus, embodiments encompass reactive hyperbranched oligomers having any combination of the Formulae provided above. In other embodiments, a reactive hyperbranched oligomer may be composed of substantially one or two structures of the Formulae presented above. For example, a hyperbranched oligomer may be composed of two units derived from branching agents (X) linked by a structure of Formula XI with branches of Formula IX, or a hyperbranched oligomer may be composed of three or four branching agents linked by structures of Formulae XI and XIII with branches of structure Formula IX. Of course, as discussed above, any combination of Formulae is possible and could be present in a single reactive hyperbranched oligomer.

An example of a reactive hyperbranched oligomer of the invention is provided below:

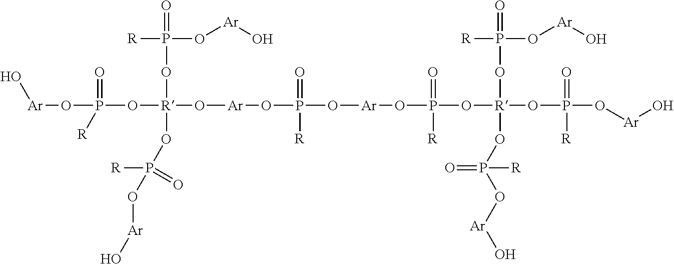

where Ar is an aryl or heteroaryl group, R is a C₁-C₄ alkyl group or an aryl group, and R′ is an alkyl or aromatic group derived from a branching agent.

In some embodiments, the molecular weight (weight average molecular weight as determined by gel permeation chromatography based on polystyrene calibration) range of the hyperbranched oligophosphonates, random or block co-oligo(phosphonate ester)s, and co-oligo(phosphonate carbonate)s may have a weight average molecular weight (Mw) of about 1,000 g/mole to about 18,000 g/mole as determined by ηᵣₑₗ or GPC, and in other embodiments, the oligomeric phosphonates may have an Mw of from about 1,000 to about 15,000 g/mole as determined by ηᵣₑₗ or GPC. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole.

The phosphonate and carbonate content of the hyperbranched oligomeric phosphonates, random or block co-oligo(phosphonate carbonate)s, and co-oligo(phosphonate ester)s may vary among embodiments, and embodiments are not limited by the phosphonate and/or carbonate content or range of phosphonate and/or carbonate content. For example, in some embodiments, the co-oligo(phosphonate carbonate)s or co-oligo(phosphonate ester)s may have a phosphorus content of from about 2% to about 20% by weight, 2% to about 12% by weight, or less than 10% by weight of the total oligomer.

The reactive hyperbranched oligomers of various embodiments may have greater than about 40% or greater than about 50% reactive end groups based on the total number of branch terminations as determined by known titration methods. In certain embodiments, the reactive hyperbranched oligomers may have greater than about 75% or greater than 90% of the reactive end groups based on the total number of branch terminations as determined by titration methods. In further embodiments, the reactive hyperbranched oligomers may have from about 40% to about 98% reactive end groups, about 50% to about 95% reactive end groups, or from about 60% to about 90% reactive end groups based on the total number of branch terminations. As discussed above, individual branch terminations may have more than one reactive end group. Therefore, in some embodiments, the reactive hyperbranched oligomers may have greater than 100% reactive end groups. As discussed above, the term “reactive end groups” is used to describe any chemical moiety at a branch termination that is capable of reacting with another chemical moiety. A large number of reactive functional groups are known in the art and encompassed by the invention. In particular embodiments, the reactive end groups may be hydroxyl, epoxy, vinyl, or isocyanate groups.

The oligomeric phosphonates of various embodiments, including linear and hyperbranched oligophosphonates, can exhibit a high molecular weight and/or a narrow molecular weight distribution (i.e., low polydispersity). For example, in some embodiments, the oligomeric phosphonates may have a weight average molecular weight (Mw) of about 1,000 g/mole to about 18,000 g/mole as determined by ηᵣₑₗ or GPC, and in other embodiments, the oligomeric phosphonates may have an Mw of from about 1,000 to about 15,000 g/mole as determined by ηᵣₑₗ or GPC. The number average molecular weight (Mn) in such embodiments may be from about 500 g/mole to about 10,000 g/mole, or from about 1,000 g/mole to about 6,000 g/mole, and in certain embodiments the Mn may be greater than about 1,500 g/mole. The narrow molecular weight distribution (i.e., Mw/Mn) of such oligomeric phosphonates may be from about 2 to about 7 in some embodiments and from about 2 to about 5 in other embodiments. In still other embodiments, the oligomeric phosphonates may have a relative viscosity of from about 1.01 to about 1.20.

Without wishing to be bound by theory, the relatively high molecular weight and narrow molecular weight distribution of the oligomeric phosphonates of the invention may impart a superior combination of properties. For example, the oligomeric phosphonates of embodiments are extremely flame retardant, exhibit superior hydrolytic stability, and can impart such characteristics on a polymer combined with the oligomeric phosphonates to produce polymer compositions such as those described below. In addition, the oligomeric phosphonates of embodiments generally exhibit an excellent combination of processing characteristics including, for example, good thermal and mechanical properties.

Each phosphonate component described above can be made by any method. In certain embodiments, the phosphonate component may be made using a polycondensation or transesterification method, and in some embodiments, the transesterification catalyst used in such methods may be a non-neutral transesterification catalyst, such as, for example, phosphonium tetraphenylphenolate, metal phenolate, sodium phenolate, sodium or other metal salts of bisphenol A, ammonium phenolate, non-halogen containing transesterification catalysts, and the like, or a combination thereof.

The oligomeric phosphates may include structural units illustrated by Formula XIV:

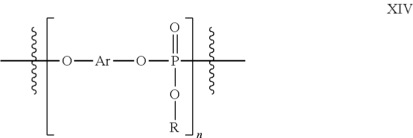

where Ar is an aromatic group and —O-Ar-O— may be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges. The oligomeric phosphates may have a weight average molecular weight (Mw) of about 300 g/mole to about 10,000 g/mole as determined by ηᵣₑₗ or GPC, and in other embodiments, the oligomeric phosphates may have an Mw of from about 500 to about 8000 g/mole as determined by ηᵣₑₗ or GPC. The number average molecular weight (Mn in such embodiments may be from about 500 g/mole to about 5000 g/mole, or from about 800 g/mole to about 1500 g/mole.

In some embodiments, oligomeric phosphonates and phosphates can be combined in the reaction mixture. For example, in some embodiments, the phosphates may be phosphate flame retardants such as, for example, trimethylphosphate, triethylphosphate, tripropylphosphate, tributylphosphate, tripentylphosphate, trihexylphosphate, tricyclohexylphosphate, triphenylphosphate, tricresylphosphate, trixylenylphosphate, dimethylethylphosphate, methyldibutylphosphate, ethyldipropylphosphate, and hydroxyphenyldiphenylphosphate. In other embodiments, the phosphates may be the oligomeric phosphates described above. In such embodiments, the oligomeric phosphonate may be provided in excess of the phosphate or oligomeric phosphate. For example, the ratio of oligomeric phosphonate to phosphate or oligomeric phosphate may be from about 10:1 to about 100:1 or any ratio or range encompassed by this example range. In other embodiments, the reaction mixtures may contain oligomeric phosphonate at a concentration of about 10 wt. % to about 40 wt. %, about 15 wt. % to about 35 wt. %, about 20 wt. % to about 35 wt. %, or any individual concentration or range encompassed by these example ranges, and a phosphate or oligomeric phosphate at a concentration of 0.5 wt. % to about 15 wt. %, about 1 wt. % to about 10 wt. %, about 2 wt. % to about 8 wt. %, or any individual concentration or range encompassed by these example ranges.

In such embodiments, the phosphate or oligomeric phosphate may be added to the reactive solvent oligomeric phosphonate mixture before this mixture is combined with the UPET. The additional phosphate or oligomeric phosphate may increase the overall phosphorous content of the reactive solvent oligomeric phosphonate mixture, while providing sufficient reactive solvent to allow for the complete dissolution of the oligomeric phosphonate. As such, the addition of phosphate or oligomeric phosphate may improve the overall flame retardancy of the cured UPET composition without disrupting the curing efficiency.

In particular embodiments, the method described above may be carried out in the absence of a co-accelerator. In other embodiments, the transition metal-containing promoter may further include a co-accelerator such as, for example, a potassium compound such as potassium oxide, potassium hydroxide, potassium C₆-C₂₀ carboxylate, potassium C₆-C₂₀ carbonate, or potassium C₆-C₂₀ hydrocarbonate. In certain embodiments, potassium carboxylate may be formed in-situ by adding potassium hydroxide to the resin composition. The amount of co-accelerator may vary among embodiments and can be from about 0.001 mmol/kg of resin to 2000 mmol/kg of resin, about 0.1 mmol/kg of resin to 200 mmol/kg of resin, about 1 mmol/kg of resin to about 150 mmol/kg resin, or about 2 to about 40 mmol/kg resin. The molar ratio of the transition metal-containing promoter and the co-accelerator may be from about 40:1 to about 1:3000 or about 25:1 to about 1:100.

In some embodiments, the curing described above may be carried out in the presence of one or more radical inhibitors. Such radical inhibitors include, for example, phenolic compounds, stable radicals like galvinoxyl and N-oxyl based compounds, catechols and/or phenothiazines. Particular examples of radical inhibitors include, but are not limited to, 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2, 6-dimethylbenzoquinone, napthoquinone, 1-oxyl-2,2,6,6-tetramethylpiperidine, 1-oxyl-2,2,6,6-tetramethylpiperidine-4-ol (TEMPOL), 1-oxyl-2,2,6,6-tetramethylpiperidine-4-one (TEMPON), 1-oxyl-2,2,6,6-tetramethyl-4-carboxyl-piperidine (4-carboxy-TEMPO), 1-oxyl-2,2,5,5-tetramethylpyrrolidine, 1-oxyl-2,2,5,5-tetramethyl-3-carboxylpyrrolidine (3-carboxy-PROXYL), aluminium-N-nitrosophenyl hydroxylamine, diethylhydroxylamine, phenothiazine, and/or derivatives or combinations of any of these compounds. The amount of radical inhibitor as used in the curing reactions described above may vary and may be chosen as a first indication of the gel time as is desired to be achieved. For example, the amount of phenolic inhibitor may be from about 0.001 mmol to about 35 mmol per kg of primary resin system or about 0.0001 wt. % to 10 wt. % or about 0.001 wt. % to 1 wt. %, calculated on the total weight of the curing composition.

In certain embodiments, the reaction mixture may further include organic additives such as bases, thiols, dioxo compounds, and the like, and combinations thereof.

In embodiments in which the reaction mixtures contain a base, the base may be any base known in the art. In some embodiments, the base may be a nitrogen-containing base such as a secondary amines- or tertiary amines-containing compound. Examples of such bases include dimethylaniline, dimethyl amine, methyl ethyl amine, methyl ethanolamine, triethylamine, triphenylamine, and the like, and combinations thereof. The base may be incorporated into the reaction mixture at a concentration of about 0.05 wt. % to about 5 wt. %, about 0.1 wt. % to 2 wt. %, about 0.25 wt. % to about 1 wt. % based on the total weight of the reaction mixture, or any individual concentration or range encompassed by these examples. In some embodiments, the molar ratio of the transition metal and the basic functionality of the base can be from about 200:1 to about 1:1500 or about 3:1 to about 1:100.

The dioxo compounds may be any dioxo compositions known in the art; for example, a 1,3-dioxo compound may be acetylacetone. The amount of the 1,3-dioxo compound included in the reaction mixture may be about 0.05 wt. % to about 5 wt. %, about 0.5 wt. % to about 2 wt. % based on the total weight of the reaction mixture, or any individual concentration or range encompassed by these example ranges.

The thiol-containing compounds that can be incorporated into the reaction mixtures may be any thiol-containing compound, and in certain embodiments, the thiol-containing compound may be an aliphatic thiol such as, for example, α-mercapto acetate or β-mercapto propionate, or a derivative or mixture thereof. The amount of thiol-containing compound may vary, and in some embodiments, the molar ratio between the transition metal and the thiol groups of the thiol-containing compound may be about 10:1 to about 1:1500 or about 1:1 to about 1:55.

Although curing may generally be carried out at room temperature (about 20° C. to about 25° C.) in the methods described above, embodiments also include curing at temperatures higher or lower than room temperature. For example, curing can be carried out at temperatures from −20° C. to 200° C., −10° C. to 100° C., 0° C. to 60° C., or any range or individual temperature encompassed by these ranges.

The reaction mixtures described above can be cured completely in less than 60 minutes, and in certain embodiments, complete curing may occur in about 2 minutes to about 30 minutes, about 5 minutes to about 20 minutes, about 7 minutes to about 15 minutes, or any time or time range encompassed by these example ranges. Complete curing results in a non-sticky or non-tacky molded article that can be easily removed from the mold.

Additional embodiments are directed to polymer compositions including UPET and oligomeric phosphate or oligomeric phosphonate and cured polymers derived from UPET and oligomeric phosphate or oligomeric phosphonate. In some embodiments, the polymer compositions and cured polymer compositions may further include monomeric phosphates or oligomeric phosphate in combination with oligomeric phosphonates. In various embodiments, the compositions may include the concentrations of components described above. For example, the polymer compositions or cured polymer compositions may contain a UPET and one or more oligomeric phosphonates, oligomeric phosphates as described above, or combinations thereof at a concentration of from about 10 wt. % to about 40 wt. %, about 15 wt. % to about 35 wt. %, about 20 wt. % to about 35 wt. %, or any individual value or range encompassed by these example ranges. In other embodiments, the polymer compositions or cured polymer compositions may include a UPET and one or more oligomeric phosphonate as described above at a concentration of from about 10 wt. % to about 40 wt. %, about 15 wt. % to about 35 wt. %, about 20 wt. % to about 35 wt. %, or any individual value or range encompassed by these example ranges, and a phosphate or oligomeric phosphate at a concentration of 0.5 wt. % to about 15 wt. %, about 1 wt. % to about 10 wt. %, about 2 wt. % to about 8 wt. %, or any individual concentration or range encompassed by these example ranges.

Further embodiments are directed to articles of manufacture containing the polymer compositions and cured polymer compositions described above. For example, in some embodiments, the polymer compositions can be used in closed-mold applications or open-mold applications in the production of cured polymers that can be used in marine applications, chemical anchoring, roofing, construction, relining, pipes, tanks, flooring, windmill blades, decorative laminates (kitchen interiors), aviation and rail applications (window frames, luggage racks/storage areas, interior wall cladding panels, folding tables etc.), and the like. Such articles of manufacture include objects or structural parts obtained by curing the polymer compositions described above. These objects and structural parts have excellent mechanical properties and excellent flame retardancy.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Preparation of Samples

Unsaturated polyester (UPET) resin used in these examples is a dicylopentadiene (DCPD)-COR61 unsaturated polyester used for laminating applications, obtained from Interplastic Corporation (Minnesota, US). The oligomeric phosphonates (Nofia OL3000 and OL5000) and diphenyl methyl phosphonate (DPP) were obtained from FRX Polymers. The oligomers were used in either pellet form or as ground powder (75-150 microns). Styrene and methyl methacrylate (MMA) were obtained from Sigma Aldrich. The flame retardants used in the formulations were obtained from commercial sources; Resorcinol bis(diphenyl phosphate) Fyroflex (RDP) from ICL and Ecoflame P-1045 (Amguard 1045) from Unibrom Corp. Cobalt 2-ethyl hexanoate (12% Cobalt) was obtained from Puritan Products, and the non-cobalt catalysts manganese based-Nouryact CF20 and copper based-Nouryact CF12 and the organic peroxide MEKP (Cadox M50a) were obtained from Akzo Nobel.

Compositions containing phosphonate oligomers (Nofia OL3000 and Nofia OL5000) were prepared by first dissolving the oligomer in styrene at 50 wt % loading. The oligomer-styrene solutions were then added to the unsaturated polyester resin and stirred until fully dissolved. Typical mixing time is 2 hours. The catalyst/promoter/co-promoter blend was then mixed into the resin system containing the flame retardants for 60 seconds before pouring into a mold. Gel time was measured at 23° C.

FR test samples (bars) were cast from silicone templates (Viton Rubber) as the substrate. The bars were 125 mm×13 mm×3 mm. The formulations are poured into each mold and placed in an oven at 50° C. overnight to complete curing.

A UL 94 vertical burn chamber was used for screening of the test samples. The bars were suspended along the vertical axis and a ¾ inch flame is applied to the sample for 10 seconds. The time to self-extinguish after the first (t₁) and second (t₂) exposure was recorded. The maximum burning time after removal of the ignition flame (tmax) should not exceed 10 seconds and the total burning time (t1+t2) for five tested specimens should not exceed 50 seconds.

### Example 1

In pellet form, the Nofia OL5000 was pre-dissolved in styrene before adding to the UPET resin. The solubility of the Nofia OL5000 in styrene was dramatically enhanced when the ground powder was used versus the pellets. At 20-30% loading of Nofia OL5000 in styrene the dissolution time decreased from 12-24 hrs to 1-2 hrs at room temperature. The ground powder can also be directly added to the UPET resin without pre-dissolving in styrene. Solubility of the Nofia OL5000 pellets in styrene was also enhanced with the addition of small amounts (2-5%) of methyl methacrylate (MMA). The results are summarized in Table 1.

TABLE 1

| Nofia OL5000 | | Solvent (Wt. %) | | Temp | Dissolution Time |
|---|---|---|---|---|---|
| Form | Wt. % | styrene | MMA | (° C.) | (hr) |
| Pellets | 20-30 | 100 | 0 | 23 | 12-24 |
| Pellets | 20-30 | 95 | 5 | 23 | 6 |
| Powder | 20-30 | 100 | 0 | 23 | 1-2 |

### Example 2

### Shelf Life Study

A 50% Nofia OL5000 solution in styrene was stable (no precipitation at room temperature) for at least one month. The shelf life at room temperature increased to 3 months when a small amount of MMA was added.

### Example 3

Compositions containing UPET resin and 20 wt % loading of various flame retardants were prepared, including; a monomeric phosphonate (DPP), a monomeric phosphate (RDP), a phosphonate dimer (Ecoflame P-1045), and two oligomeric phosphonates (Nofia OL3000 and Nofia OL5000). The compositions were cured using 0.2 wt. % cobalt 2-ethylhexanoate and 1.5 wt. % methyl ethyl ketone peroxide (MEK-P). The gel times at room temperature (RT) are presented in TABLE 2 below:

TABLE 2

| | | FR additive | Gel time at RT |
|---|---|---|---|
| | Description | (wt. %) | (min) |
| No FR | none | 0 | 9 |
| RDP | resorcinol diphosphate | 20 | 10 |
| DPP | diphenyl methylphosphonate | 20 | 15 |
| Ecoflame | phosphonate dimer | 20 | >60 |
| P-1045 | | | |
| Nofia | phosphonate oligomer | 20 | >60 |
| OL3000 | | | |
| Nofia | phosphonate oligomer | 20 | >60 |
| OL5000 | | | |

Based on this data, monomeric phosphonates or phosphates (RDP and DPP) have little impact on gel time, while the addition of phosphonate dimers and oligomers significantly impact gel time.

### Example 4

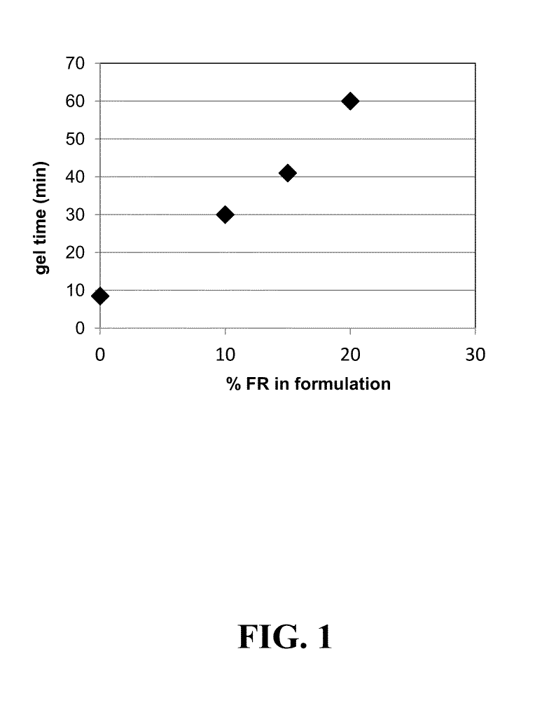

Compositions containing UPET resin, and varying concentrations of Nofia OL5000, using a catalyst system of 0.2 wt. % cobalt 2-ethylhexanoate and 1.5 wt. % methyl ethyl ketone peroxide. The results, showing increased gel time as a function of OL5000 concentration, are provided in FIG. 1.

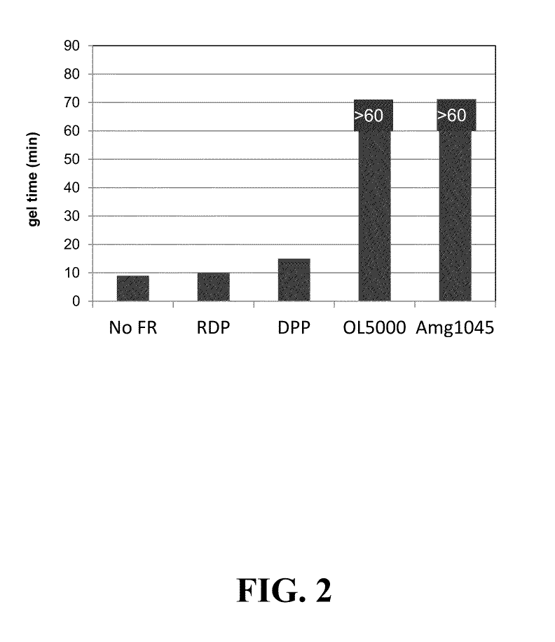

These results were compared to a monomeric phosphate resorcinol diphenyl phosphate (RDP), a monomeric phosphonate diphenyl methyl phosphonate (DPP), and dimeric phosphonate (Ecoflame P-1045/AMGUARD 1045) at 20 wt. % loading using the same catalyst system. The results are provided in FIG. 2. At only 10 wt % of Nofia OL5000, the gel time was already about three times longer than for the UPET without any FR or a UPET formulation with 20 wt % of a monomeric phosphate or phosphonate. At 20 wt % Nofia OL5000 the gel time was more than about six times longer than those formulations.

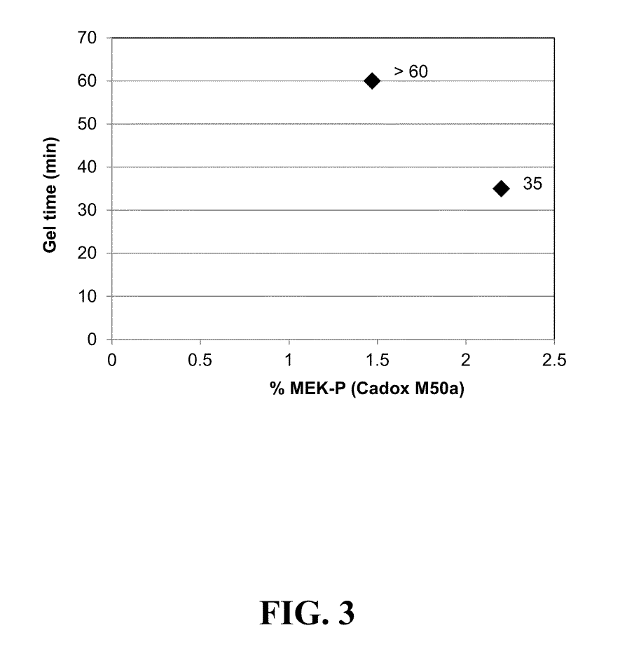

As indicated in FIG. 3, increasing MEK-P concentration reduces gel time, but does not reduce gel time to that of the control. A 50% increase in MEK-P results in a gel time that is about 3× longer than that of the formulation without any flame retardant or a formulation with the monomeric phosphate or phosphonate.

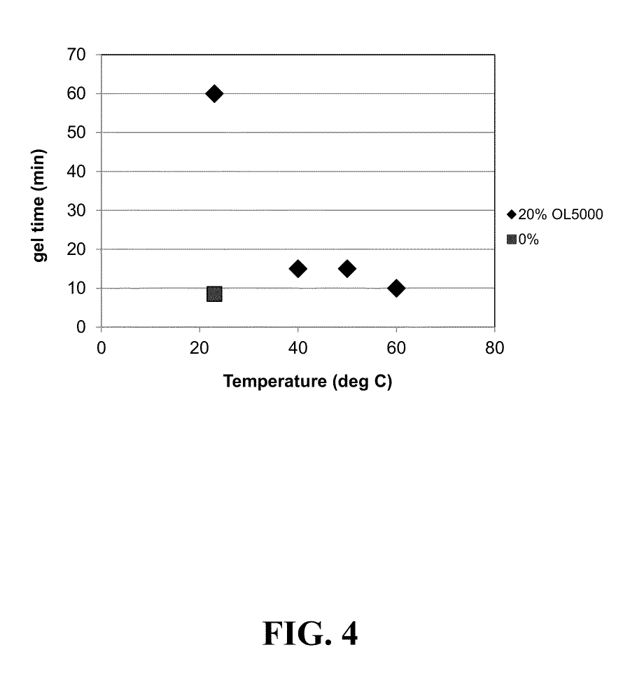

Increasing the curing temperature from RT to 60° C. reduces the gel time of compositions containing 20% Nofia OL5000 to the control gel times (using the catalyst system described above), as illustrated in FIG. 4.

Taken together, these data show that long gel times (>30 min) are observed when >10% of dimeric or oligomeric phosphonates are added to Cobalt/MEKP system at RT. Only gel times similar to control (no flame retardant) at RT can be achieved by increasing the temperature to 60° C. with 20% Nofia OL5000 loading.

### Example 5

Compositions containing (UPET), an oligomeric phosphonate flame retardant (Nofia OL5000), were cured using 1.5 wt. % manganese-based promoter (Nouryact™ CF20) and 1.5 wt. % methyl ethyl ketone peroxide (MEK-P). The gel times at room temperature (RT) are presented in TABLE 3 below:

TABLE 3

| | | FR additive | Gel time at RT |
|---|---|---|---|
| | Description | (wt. %) | (min) |
| No FR | none | 0 | 8.5 |
| Nofia | phosphonate oligomer | 20 | 15 |
| OL5000 | | | |

Replacing the cobalt based promoter with a manganese based promoter did not significantly change the gel time for a No FR based system (compare to Table 2). However, surprisingly, for a system containing Nofia OL5000, replacing the cobalt based promoter by the manganese based promoter, the gel time was decreased from >60 min to 15 min.

### Example 6

Compositions containing (UPET), oligomeric phosphonate flame retardants (FR) were cured using 1.5 wt. % copper-based promoter Nouryact™ CF12 and 1.5 wt. % methyl ethyl ketone peroxide (MEK-P). The gel times at room temperature (RT) are presented in TABLE 4 below:

TABLE 4

| | | FR additive | Gel time at RT |
|---|---|---|---|
| | Description | (wt. %) | (min) |
| No FR | none | 0 | 7.5 |
| Nofia | phosphonate oligomer | 20 | 13 |
| OL5000 | | | |

Replacing the cobalt based promoter with a copper based promoter did not significantly change the gel time for a No FR based system (compare to Table 2). However, surprisingly, for a system containing Nofia OL5000, replacing the cobalt based promoter by the copper based promoter, the gel time was decreased from >60 min to only 13 min.

### Example 7

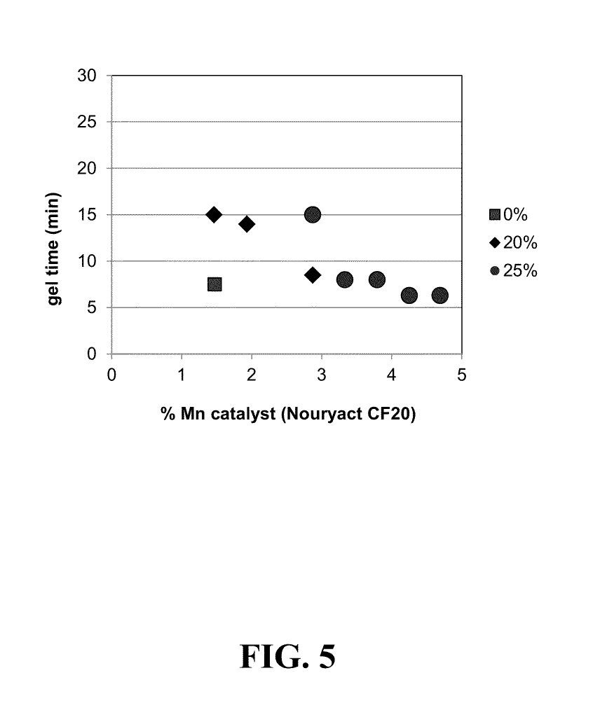

The reactions described above were carried out in the presence of a manganese catalyst system (Nouryact CF20) and 1.5 wt. % MEK-P (Cadox M50A). As illustrated in FIG. 5, at equal concentrations of Nouryact CF20 (1.5 wt. %), gel time increased for reaction mixtures including 20 wt. % OL5000; however, gel time was reduced to about the same as the 0% OL5000 control by increasing the Nouryact CF20 concentration to 3.0 wt. %. Similarly, increasing the concentration of Nouryact CF20 to 3.0 wt. % or greater allowed for gel time reduction to about the same as 0% control at Nofia OL5000 concentrations of 25 wt. %. The results are illustrated in FIG. 5.

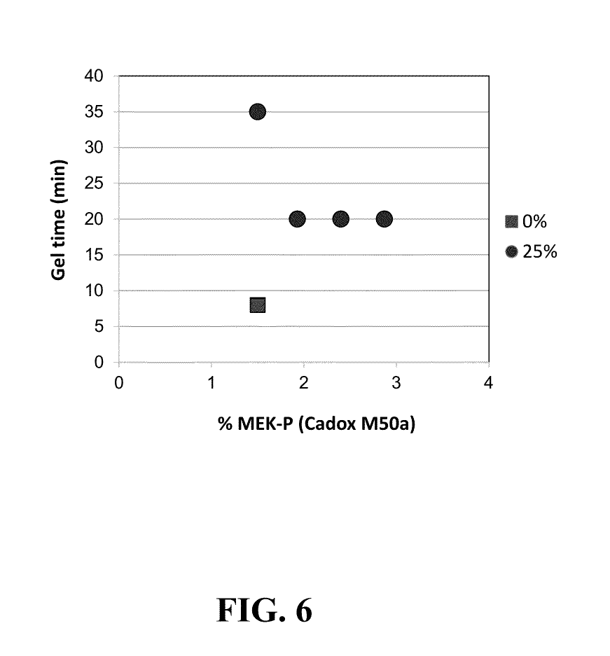

For UPET resin compositions containing 25% Nofia OL5000 and cured using 1.5 wt. % Nouryact CF20, increasing the MEK-P concentration from 1.5% to 1.93% decreased the gel time from 35 min to 20 min, but further increase in MEK-P concentrations above 2% did not lead to further reduction in gel times as illustrated by FIG. 6.

### Example 8

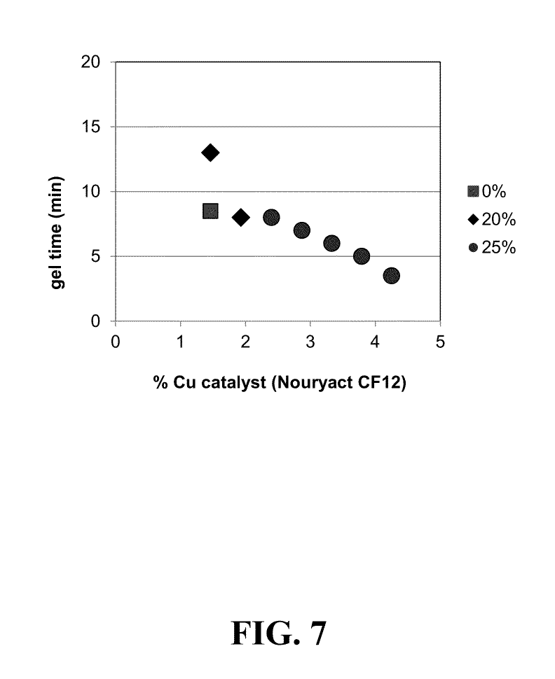

The reactions described above were carried out in the presence of a copper catalyst system (1.5 wt % Nouryact CF 12) with 1.5 wt. % MEK-P (Cadox M50A). As illustrated in FIG. 7, minimal increase in the gel time for the composition containing 20 wt. % Nofia OL5000 compared to the formulation without any FR was observed at equal concentrations of Nouryact CF12 (1.5 wt. %). Slightly increasing the concentration of Nouryact CF12 from 1.5 wt % to 1.93 wt % allowed for gel time reduction comparable to that of the 0% control at Nofia OL5000 concentrations of 20 wt. % and 25 wt. %.

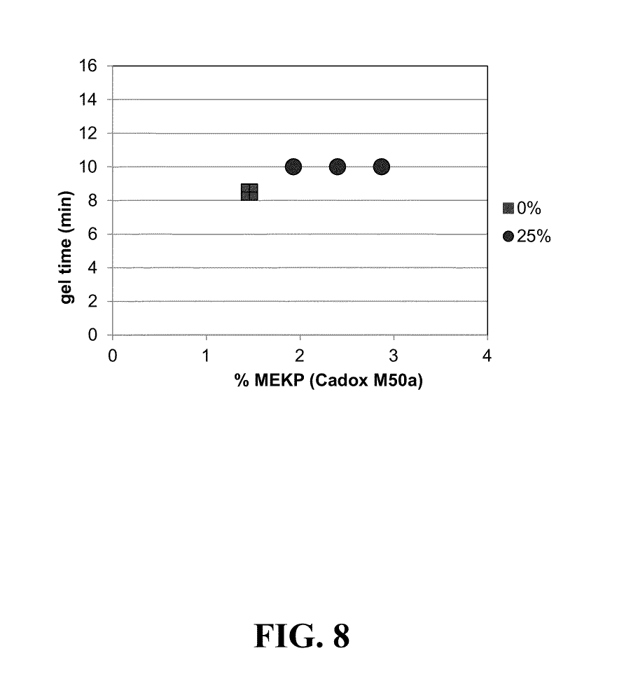

Like the manganese catalyst system, increasing the MEK-P concentration had no effect on gel time, as illustrated in FIG. 8.

Examples 4, 5, 6, and 7 show that cobalt-based catalyst systems inhibit room temperature curing of UPET compositions containing oligomeric phosphonates or oligomeric phosphates. This inhibition is not observed for manganese- and copper-based catalyst systems.

### Example 9

Flame retardancy of compositions containing neat OL5000 were compared to mixtures with Ecoflame P-1045 (Amguard 1045). The Nofia OL5000 was pre-dissolved in styrene at 60% solids and then added to the UPET resin. For mixtures containing Amguard, Amguard was dissolved in the Nofia OL5000 solution in styrene before adding to the UPET. The formulations were poured into a mold of 125 mm×13 mm and 1.5 mm thick and cured using 0.2 wt. % cobalt 2-ethylhexanoate and 1.5 wt. % MEK-P at 50° C. overnight. Table 5 shows the burn data for neat Nofia OL5000 solutions and mixtures of Nofia OL5000 with Amguard (Examples 9-1 to 9-4). The addition of Amguard reduces the total amount of styrene in the mixture, which improves the flammability of the system at the same level of phosphorus. Comparative examples with RDP (monomeric phosphate) (Examples 9-5 and 9-6) in Table 6 did not provide the same improvement in FR when added to Nofia OL5000.

TABLE 5

| | | | | | Max burn | Total burn |
|---|---|---|---|---|---|---|
| | | Ecoflame/ | | | time | time |
| | OL5000 | Amguard | Styrene | Total | (tmax) | (t1 + t2) |
| Ex | (wt %) | 1045 (wt %) | (wt %) | % P | (s) | (s) |
| 9-1 | 30 | 0 | 32 | 3.0 | >30 | >50 |
| 9-2 | 20 | 10 | 26 | 4.1 | 1 | 2 |
| 9-3 | 20 | 5 | 27 | 3.0 | 6 | 11 |
| 9-4 | 35 | 0 | 32 | 3.5 | >30 | >50 |
| 9-5 | 25 | 5 | 28 | 3.5 | 1 | 2 |

TABLE 6
Comparative examples with RDP (9-6) and TEP (9-7)

| | | | | | Max burn | Total burn |
|---|---|---|---|---|---|---|
| | | | | | time | time |
| | OL5000 | Phosphate | Styrene | Total | (tmax) | (t1 + t2) |
| Ex. | (wt %) | (wt %) | (wt %) | % P | (s) | (s) |
| 9-6 | 25 | 5 | 28 | 3.0 | >30 | >50 |
| 9-7 | 25 | 10 | 27 | 3.6 | >30 | >50 |

1. A composition comprising:
an unsaturated polyester;
an oligomeric phosphonate, oligomeric phosphate, or combinations thereof; and
a cobalt-free catalyst system.

2. The composition of claim 1, wherein the cobalt-free catalyst system comprises a transition metal-containing promoter selected from the group consisting of copper¹⁺ compounds, copper²⁺ compounds, iron²⁺ salts, iron³⁺ compounds, iron²⁺ salts, organic iron²⁺ salts, iron³⁺ salts, organic iron³⁺ salts, manganese²⁺ salts or complexes, manganese³⁺ salts or complexes, organic manganese²⁺ salts, organic manganese³⁺ salts, titanium compounds, and organotitanium compounds.

3. The composition of claim 1, wherein the cobalt-free catalyst system comprises a transition metal-containing promoter selected from the group consisting of copper carboxylates, copper acetoacetates, copper chlorides, iron carboxylate, iron acetoacetate, manganese carboxylate, manganese acetoacetate, titanium alkoxidetitanium propoxide, titanium butoxide, titanium carboxylate, and combinations thereof.

4. The composition of claim 1, wherein the oligomeric phosphonate has a weight average molecular weight (Mw) of about 1,000 g/mole to about 18,000 g/mole, as determined by lire′ or GPC.

5. The composition of claim 1, wherein the phosphonate component has a number average molecular weight (Mn) of about 500 g/mole to about 10,000 g/mole.

6. The composition of claim 1, wherein the phosphonate component has a molecular weight distribution (Mw/Mn) of about 2 to about 7.

7. The composition of claim 1, wherein the phosphonate component has a relative viscosity of from about 1.01 to about 1.20.

8. The composition of claim 1, wherein the phosphonate component has a phosphorous content of about 1% to about 20% by weight.

9. The composition of claim 1, wherein the oligomeric phosphonate is of Formula I: 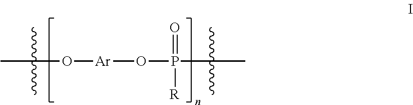
wherein:
Ar is an aromatic group and —O-Ar-O— is derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations thereof;
R is a C₁₋₂₀ alkyl, C₂₋₂₀ alkene, C₂₋₂₀ alkyne, C₅₋₂₀ cycloalkyl, or C₆₋₂₀ aryl; and
n is an integer from 1 to about 20.

10. The composition of claim 1, wherein the oligomeric phosphonate is of Formula II: 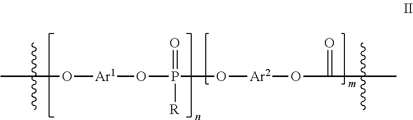
wherein:
Ar¹ and Ar² are aromatic groups and each —O-Ar¹-O— and —O-Ar²-O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof;
each R is, independently, C₁₋₂₀ alkyl, C₂₋₂₀ alkene, C₂₋₂₀ alkyne, C₅₋₂₀ cycloalkyl, or C₆₋₂₀ aryl; and
each m and n is, independently, an integer from 1 to about 20.

11. The composition of claim 1, wherein the oligomeric phosphonate is of Formula III: 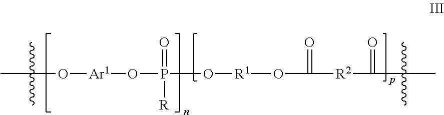
wherein:
Ar¹ is an aromatic group and each —O-Ar¹-O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof;
each R is, independently, C₁₋₂₀ alkyl, C₂₋₂₀ alkene, C₂₋₂₀ alkyne, C₅₋₂₀ cycloalkyl, or C₆₋₂₀ aryl;
each R¹ and R² are, individually, aliphatic or aromatic hydrocarbons; and
each n and p is, independently, an integer from 1 to about 20.

12. The composition of claim 1, wherein the oligomeric phosphonate is selected from the group consisting of compounds of Formulae IV, V, and VI: 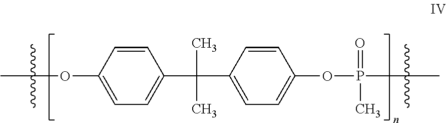
wherein n is 1 to 20; 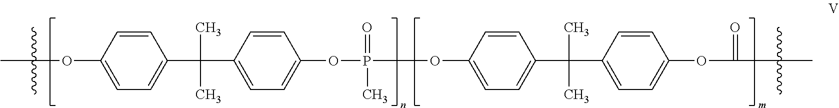
wherein each n and m is, individually, 1 to 20; and 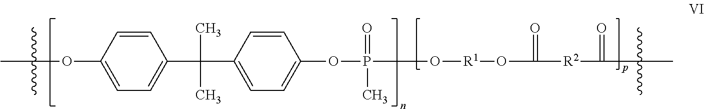
wherein each n and p is, individually, 1 to 20.

13. The composition of claim 1, comprising about 10% to about 40% by weight oligomeric phosphonate.

14. The composition of claim 1, wherein the oligomeric phosphate is of Formula XIV: 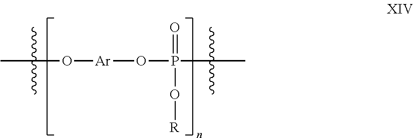
wherein:
Ar is an aromatic group and —O-Ar-O— derived from resorcinol, hydroquinone, bisphenols, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of thereof;
R is a C₁₋₂₀ alkyl, C₂₋₂₀ alkene, C₂₋₂₀ alkyne, C₅₋₂₀ cycloalkyl, or C₆₋₂₀ aryl, and
n is an integer from 1 to about 20.

15. The composition of claim 1, wherein the oligomeric phosphates have a weight average molecular weight (Mw) of about 300 g/mole to about 10,000 g/mole as determined by ηrel or GPC.

16. The composition of claim 1, wherein the oligomeric phosphates have a number average molecular weight (Mn) from about 500 g/mole to about 5000 g/mole.

17. The composition of claim 1, wherein the oligomeric phosphate is selected from the group consisting of trimethylphosphate, triethylphosphate, tripropylphosphate, tributylphosphate, tripentylphosphate, trihexylphosphate, tricyclohexylphosphate, triphenylphosphate, tricresylphosphate, trixylenylphosphate, dimethylethylphosphate, methyldibutylphosphate, ethyldipropylphosphate, and hydroxyphenyldiphenylphosphate.

18. The composition of claim 1, comprising about 0.5 wt. % to about 15 wt. % oligomeric phosphate.

19. The composition of claim 1, wherein the ratio of oligomeric phosphonate to oligomeric phosphate is about 10:1 to about 100:1.

20. The composition of claim 1, wherein the unsaturated polyester is selected from the group consisting of ortho-resins derived from phthalic anhydride, maleic anhydride, or fumaric acid and glycol, 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins derived from isophthalic acid, maleic anhydride or fumaric acid, and glycol, bisphenol-A-fumarates derived from bisphenol-A and fumaric acid, chlorendics derived from chlorine/bromine containing anhydrides or phenols, vinyl ester resins, vinyl ester resins containing epoxy resins, diglycidyl ether of bisphenol-A, epoxies of the phenol-novolac type, or epoxies based on tetrabromobisphenol-A reacted with (meth)acrylic acid or acrylamide monomers.

21. The composition of claim 1, further comprising one or more additives selected from the group consisting of fillers, lubricants, surfactants, organic binders, polymeric binders, crosslinking agents, coupling agents, anti-dripping agents, fluoropolymers, heat and light stabilizers, antistatic agents, antioxidants, nucleating agents, carbodiimide, colorants, inks, dyes, UV absorbers and light stabilizers, 2-(2,′-hydroxyphenyl)-benzotriazoles, 2-hydroxybenzophenones, esters of optionally substituted benzoic acids, acrylates, nickel compounds, sterically hindered amines, oxalic acid diamides, metal deactivators, phosphites, phosphonites, compounds that destroy peroxide, basic costabilizers, nucleating agents, reinforcing agents, plasticizers, emulsifiers, pigments, optical brighteners, antistatics, blowing agents, and combinations thereof.

22. An article of manufacture comprising the compound of claim 1.

23. The article of manufacture of claim 22, wherein the article is selected from the group consisting of fibers, films, sheets, and molded articles.

24. A method for producing a cured polymer comprising:
combining an unsaturated polyester, oligomeric phosphonate, oligomeric phosphate, or combinations thereof, and a cobalt-free catalyst system to form a reaction mixture; and
curing the reaction mixture at room temperature.

25. The method of claim 24, wherein the curing occurs in less than about 60 minutes.

26. The method of claim 24, wherein the cobalt-free catalyst system comprises a transition metal-containing promoter selected from the group consisting of copper¹⁺ compounds, copper²⁺ compounds, iron²⁺ salts, iron³⁺ compounds, iron²⁺ salts, organic iron²⁺ salts, iron³⁺ salts, organic iron³⁺ salts, manganese²⁺ salts or complexes, manganese³⁺ salts or complexes, organic manganese²⁺ salts, organic manganese³⁺ salts, titanium compounds, and organotitanium compounds.

27. The method of claim 24, wherein the cobalt-free catalyst system comprises a transition metal-containing promoter selected from the group consisting of copper carboxylates, copper acetoacetates, copper chlorides, iron carboxylate, iron acetoacetate, manganese carboxylate, manganese acetoacetate, titanium alkoxidetitanium propoxide, titanium butoxide, titanium carboxylate, and combinations thereof

28. The method of claim 24, wherein the oligomeric phosphonate has a weight average molecular weight (Mw) of about 1,000 g/mole to about 18,000 g/mole, as determined by ηᵣₑₗ or GPC.

29. The method of claim 24, wherein the phosphonate component has a number average molecular weight (Mn) of about 500 g/mole to about 10,000 g/mole.

30. The method of claim 24, wherein the phosphonate component has a molecular weight distribution (Mw/Mn) of about 2 to about 7.

31. The method of claim 24, wherein the phosphonate component has a relative viscosity of from about 1.01 to about 1.20.

32. The method of claim 24, wherein the phosphonate component has a phosphorous content of about 1% to about 20% by weight.

33. The method of claim 24, wherein the oligomeric phosphonate is of Formula I: 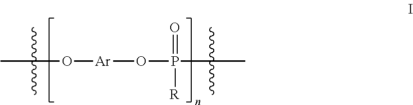
wherein:
Ar is an aromatic group and —O-Ar-O— is derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations thereof;
R is a C₁₋₂₀ alkyl, C₂₋₂₀ alkene, C₂₋₂₀ alkyne, C₅₋₂₀ cycloalkyl, or C₆₋₂₀ aryl; and
n is an integer from 1 to about 20.

34. The method of claim 24, wherein the oligomeric phosphonate is of Formula II: 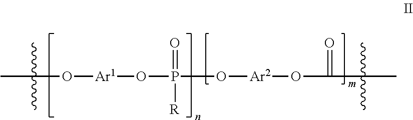
wherein:
Ar¹ and Ar^{e} are aromatic groups and each —O-Ar¹-O— and —O-Ar²-O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof;
each R is, independently, C₁₋₂₀ alkyl, C₂₋₂₀ alkene, C₂₋₂₀ alkyne, C₅₋₂₀ cycloalkyl, or C₆₋₂₀ aryl; and
each m and n is, independently, an integer from 1 to about 20.

35. The method of claim 24, wherein the oligomeric phosphonate is of Formula III: 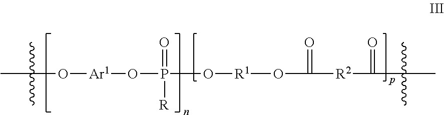
wherein:
Ar¹ is an aromatic group and each —O-Ar¹-O— is, individually, derived from resorcinol, hydroquinone, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, and combinations thereof;
each R is, independently, C₁₋₂₀ alkyl, C₂₋₂₀ alkene, C₂₋₂₀ alkyne, C₅₋₂₀ cycloalkyl, or C₆₋₂₀ aryl;
each R¹ and R² are, individually, aliphatic or aromatic hydrocarbons; and
each n and p is, independently, an integer from 1 to about 20.

36. The method of claim 24, wherein the oligomeric phosphonate is selected from the group consisting of compounds of Formulae IV, V, and VI: 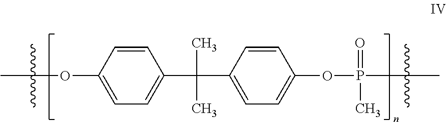
wherein n is 1 to 20; 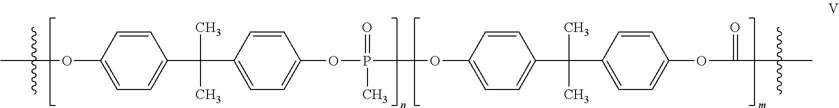
wherein each n and m is, individually, 1 to 20; and 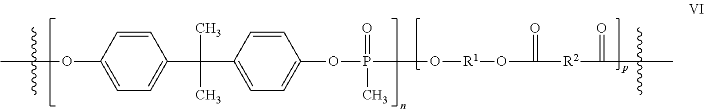
wherein each n and p is, individually, 1 to 20.

37. The method of claim 24, comprising about 10% to about 40% by weight oligomeric phosphonate.

38. The method of claim 24, wherein the oligomeric phosphate is of Formula XIV: 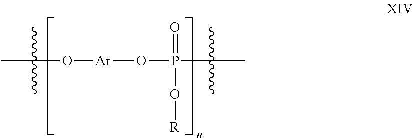
wherein:
Ar is an aromatic group and —O-Ar-O— derived from resorcinol, hydroquinone, bisphenols, bisphenol A, bisphenol F, 4,4′-biphenol, phenolphthalein, 4,4′-thiodiphenol, 4,4′-sulfonyldiphenol, 1,1-bis-(4-hydroxyphenyl)-3,3,5-trimethylcyclohexane, or combinations of thereof;
R is a C₁₋₂₀ alkyl, C₂₋₂₀ alkene, C₂₋₂₀ alkyne, C₅₋₂₀ cycloalkyl, or C₆₋₂₀ aryl, and
n is an integer from 1 to about 20.

39. The method of claim 24, wherein the oligomeric phosphates have a weight average molecular weight (Mw) of about 300 g/mole to about 10,000 g/mole as determined by ηrel or GPC.

40. The method of claim 24, wherein the oligomeric phosphates have a number average molecular weight (Mn) in such embodiments may be from about 500 g/mole to about 5000 g/mole.

41. The method of claim 24, wherein the oligomeric phosphate is selected from the group consisting of trimethylphosphate, triethylphosphate, tripropylphosphate, tributylphosphate, tripentylphosphate, trihexylphosphate, tricyclohexylphosphate, triphenylphosphate, tricresylphosphate, trixylenylphosphate, dimethylethylphosphate, methyldibutylphosphate, ethyldipropylphosphate, and hydroxyphenyldiphenylphosphate.

42. The method of claim 24, wherein the reaction mixture comprises about 0.5 wt. % to about 15 wt. % oligomeric phosphate.

43. The method of claim 24, wherein the ratio of oligomeric phosphonate to oligomeric phosphate is about 10:1 to about 100:1.

44. The method of claim 24, wherein the unsaturated polyester is selected from the group consisting of ortho-resins derived from phthalic anhydride, maleic anhydride, or fumaric acid and glycol, 1,2-propylene glycol, ethylene glycol, diethylene glycol, triethylene glycol, 1,3-propylene glycol, dipropylene glycol, tripropylene glycol, neopentyl glycol or hydrogenated bisphenol-A, iso-resins derived from isophthalic acid, maleic anhydride or fumaric acid, and glycol, bisphenol-A-fumarates derived from bisphenol-A and fumaric acid, chlorendics derived from chlorine/bromine containing anhydrides or phenols, vinyl ester resins, vinyl ester resins containing epoxy resins, diglycidyl ether of bisphenol-A, epoxies of the phenol-novolac type, or epoxies based on tetrabromobisphenol-A reacted with (meth)acrylic acid or acrylamide monomers.

45. A composition comprising a reactive solvent, an oligomeric phosphonate, and an acrylate.

46. The composition of claim 45, wherein the reactive solvent is selected from the group consisting of α-methyl styrene, (meth)acrylates, N-vinylpyrrolidone, N-vinylcaprolactam, and styrene.

47. The composition of claim 45, wherein the acrylate is selected from the group consisting of methyl methacrylate (MMA), ethyl methacrylate (EMA), butyl methacrylate (BMA), or 2-ethyl hexyl methacrylate (2-EHMA), or monomers such as, p-vinyltoluene, α-methyl styrene, diallyl phthalate, and triallyl cyanurate.

48. The composition of claim 45, comprising about 20% to about 60% by weight oligomeric phosphonate.

49. The composition of claim 45, wherein the oligomeric phosphonate is selected from the oligomeric phosphonates of claims 9 to 12.
